(19) United States
(12) Patent Application Publication
(10) Pub. No.: US 2008/0068402 A1
(43) Pub. Date: Mar. 20, 2008

(54) IMAGE DISPLAY METHOD AND IMAGE DISPLAY DEVICE

(75) Inventors: Ken Ioka, Tokyo (JP); Hiroshi Sakai, Sagamihara-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 11/855,689

(22) Filed: Sep. 14, 2007

(30) Foreign Application Priority Data
Sep. 15, 2006 (JP) 2006-251140
May 29, 2007 (JP) 2007-141895

(51) Int. Cl. G09G 5/02; G06T 11/40

(52) U.S. Cl. 345/660; 345/552

(57) ABSTRACT

An image display device includes an image division unit 12 dividing an input image into a plurality of image segments partly overlapping each other, an image enlargement unit 13 enlarging the plurality of image segments to form a plurality of enlarged image segments, an output image formation unit 15 forming a plurality of output images corresponding to spatially different display positions from the plurality of enlarged image segments, an image display unit 17 successively displaying a plurality of output images, and a pixel shifting control unit 18 spatially shifting display positions indicated by image display unit 17 so that respective output images are displayed at corresponding display positions synchronizing with the successive displays of the plurality of output images.

### BACKGROUND OF THE INVENTION

1. Field of the Invention

The present invention relates to an image display method and an image display device which display input images at a high resolution.

2. Description of Related Art

In recent years, with the diffusion of high definitions television (HDTV), HD resolution contents have become widely provided. Also, as for the display devices, HD-capable devices have increased.

Meanwhile, lately, dot matrix type flat panel displays (FPD) such as liquid crystal display (LCD), plasma display panel (PDP), liquid crystal on silicon (LCOS) and the like have been variously proposed for use in large screens. However, with such large screen dot matrix type display devices, although being HD-capable, the display pixels may be visible at a certain watching distance so that there are concerns that these may be recognized as degradation of image quality.

As a method to prevent this, it may be suggested that the number of pixels of the display device be increased, in order to obtain a higher resolution. Another method may also be possible, which forms a plurality of sub-frame images each corresponding to the resolution of the display device from the input image, and displays these sub-frame images with pixels shifted (for example, refer to JP 2004-70,358 A).

However, if the method of increasing the number of pixels is applied to a dot matrix type display device, the increase in the number of pixels creates a new problem of notable rise in the cost. Even if the pixels were increased and a high resolution were realized, the realization of high pixel contents corresponding to the number of pixels would be difficult in the near future, due to the limit of broadcast format.

On the other hand, in the above mentioned prior art method, the number of pixels of input image is doubled by calculation depending on the number of pixel shifting, then sub-frame images corresponding to the pixel shifting positions are formed from the processed doubled image. For this purpose, for example, if the display device is HD-capable and the input image is HD, an attempt to perform four point pixel shifting will require enlargement of the number of pixels of the input image of HD resolution to four times, and the formation of sub-frame images of the HD resolution for the four images corresponding to the four point pixel shifting positions.

However, in order to form these HD resolution sub-frame images after the number of pixels of input image of HD resolution is doubled, the image processing circuit to be used becomes more expensive, and the processing speed will be insufficient which will result in cost rise of the overall system and a fall of processing speed.

### DISCLOSURE OF THE INVENTION

Thus, the object of the present invention, invented considering such points, is to provide an image display method and an image display device of low cost, which may display input images at a high resolution and be capable of high-speed processing.

The invention of the image display method according to claim 1 which achieves the object mentioned above comprises a step of dividing an input image into a plurality of image segments partly overlapping each other, a step of enlarging said plurality of image segments, respectively, to form a plurality of enlarged image segments, a step of forming from said plurality of enlarged image segments a plurality of output images corresponding to display positions spatially different from each other, and a step of successively displaying said plurality of output images by an image display unit, while spatially shifting the display positions of the output images by said image display unit in a manner that said plurality of output images are successively displayed at the respective corresponding display positions by said image display unit.

The invention of the image display method according to claim 2 comprises a step of sampling an input image, a step of dividing said sampled image into a plurality of image segments partly overlapping each other, a step of enlarging or diminishing said plurality of image segments, respectively, to form a plurality of scaling image segments, a step of forming from said plurality of scaling image segments a plurality of output images corresponding to display positions spatially different from each other, and a step of successively displaying said plurality of output images by an image display unit, while spatially shifting the display positions of the output images by said image display unit in a manner that said plurality of output images are successively displayed at the respective corresponding display positions by said image display unit.

The invention of the image display method according to claim 3 comprises a step of capturing an image, a step of dividing said captured image into a plurality of image segments partly overlapping each other, a step of enlarging or diminishing said plurality of image segments, respectively, to form a plurality of scaling image segments, a step of forming from said plurality of scaling image segments a plurality of output images corresponding to display positions spatially different from each other, and a step of successively displaying said plurality of output images by an image display unit, while spatially shifting the display positions of the output images by said image display unit in a manner that said plurality of output images are successively displayed at the respective corresponding display positions by said image display unit.

The invention of the image display method according to claim 4 comprises a step of sampling an input image, a step of dividing said sampled image into a plurality of image segments partly overlapping each other, a step of enlarging or diminishing said plurality of image segments, respectively, to form a plurality of scaling image segments, a step of forming from said plurality of scaling image segments a plurality of output images corresponding to display positions spatially different from each other, a step of superimposing required data on said plurality of output images respectively, and a step of successively displaying said plurality of superimposed output images by an image display unit, while spatially shifting the display positions of the output images by said image display unit in a manner that said plurality of superimposed output images are successively displayed at the respective corresponding display positions by said image display unit.

invention of the image display method according to claim 5 comprises a step of capturing an image, a step of dividing said captured image into a plurality of image segments partly overlapping each other, a step of enlarging or diminishing said plurality of image segments, respectively, to form a plurality of scaling image segments, a step of forming from said plurality of scaling image segments a plurality of output images corresponding to display positions spatially different from each other, a step of superimposing required data onto said plurality of output images respectively, and a step of successively displaying said plurality of superimposed output images by an image display unit, while spatially shifting the display positions of the output images by said image display unit in a manner that said plurality of superimposed output images are successively displayed at the respective corresponding display positions by said image display unit.

Moreover, the invention of the image display device according to claim 6 which achieves the object mentioned above comprises an image division unit for dividing an input image into a plurality of image segments partly overlapping each other, an image enlargement unit for enlarging said plurality of image segments to form a plurality of enlarged image segments, an output image formation unit for forming from said plurality of enlarged image segments a plurality of output images corresponding to display positions spatially different from each other, an image display unit for successively displaying said plurality of output images, and a pixel shifting control unit for spatially shifting the display positions indicated by said image display unit so that the respective output images are displayed at their corresponding display positions synchronizing with the successive displays of said plurality of output images.

The invention of the image display device according to claim 7 comprises a sampling unit for sampling an input image, an image division unit for dividing said image sampled by said sampling unit into a plurality of image segments partly overlapping each other, an image scaling unit for forming a plurality of scaling image segments by enlarging or diminishing said plurality of image segments divided by said image division unit respectively, an output image formation unit for forming from said plurality of scaling image segments formed by said image scaling unit a plurality of output images corresponding to display positions spatially different from each other, an image display unit for successively displaying said plurality of output images formed by said output image formation unit, and a pixel shifting control unit for spatially shifting the display positions indicated by said image display unit so that the respective output images are displayed at their corresponding display positions synchronizing with the successive displays of said plurality of output images on said image display unit.

The invention of the image display device according to claim 8 comprises an image capturing unit for capturing an image, an image division unit for dividing the image captured by said image capturing unit into a plurality of image segments partly overlapping each other, an image scaling unit for forming a plurality of scaling image segments by enlarging or diminishing said plurality of image segments divided by said image division unit respectively, an output image formation unit for forming from said plurality of scaling image segments formed by said image scaling unit a plurality of output images corresponding to display positions spatially different from each other, an image display unit for successively displaying said plurality of output images formed by said output image formation unit, and a pixel shifting control unit for spatially shifting the display positions indicated by said image display unit so that the respective output images are displayed at their corresponding display positions synchronizing with the successive displays of said plurality of output images on said image display unit.

The invention of the image display device according to claim 9 comprises a sampling unit for sampling an input image, an image division unit for dividing said image sampled by said sampling unit into a plurality of image segments partly overlapping each other, an image scaling unit for forming a plurality of scaling image segments by enlarging or diminishing said plurality of image segments divided by said image division unit respectively, an output image formation unit for forming from said plurality of scaling image segments formed by said image scaling unit a plurality of output images corresponding to display positions spatially different from each other, a superimpose unit for superimposing required data onto the plurality of output images formed by said output image formation unit respectively, an image display unit for successively displaying the plurality of output images superimposed by said superimpose unit, and a pixel shifting control unit for spatially shifting the display positions indicated by said image display unit so that the respective output images are displayed at their corresponding display positions synchronizing with the successive displays of said plurality of superimposed output images on said image display unit.

The invention of the image display device according to claim 10 comprises an image capturing unit for capturing an image, an image division unit for dividing the image captured by said image capturing unit into a plurality of image segments partly overlapping each other, an image scaling unit for forming a plurality of scaling image segments by enlarging or diminishing said plurality of image segments divided by said image division unit respectively, an output image formation unit for forming from said plurality of scaling image segments formed by said image scaling unit a plurality of output images corresponding to display positions spatially different from each other, a superimpose unit for superimposing the data necessary for the plurality of output images formed by said output image formation unit respectively, an image display unit for successively displaying the plurality of output images superimposed by said superimpose unit, and a pixel shifting control unit for spatially shifting the display positions indicated by said image display unit so that the respective output images are displayed at their corresponding display positions synchronizing with the successive displays of said plurality of superimposed output images on said image display unit.

The invention according to claim 11 comprises, in the image display unit described in any of claims 6 to 10, an image division parameter input unit for setting overlapping regions of said plurality of image segments formed by said image division unit.

The invention according to claim 12 comprises, in the image display unit described in any of claims 6 to 11, a plurality of image segment memories for memorizing said plurality of image segments, respectively, a plurality of enlarged image segment memories for memorizing said plurality of enlarged image segments, respectively, and a plurality of output image memories for memorizing said plurality of output images, respectively.

The invention according to claim 13 resides in the image display device described in any of claims 6 to 12, wherein said image enlargement unit comprises a plurality of image enlargement circuits for enlarging said plurality of image segments, respectively, and said output image formation unit comprises a plurality of output image formation circuits for forming said plurality of output images, respectively.

According to the present invention, after an input image is divided into a plurality of image segments partly overlapping one another, the plurality of image segments thus divided are respectively enlarged or diminished to form a plurality of enlarged image segments. These plurality of enlarged or diminished image segments are then used to form a plurality of output images corresponding to spatially different display positions, and these plurality of formed output images are displayed by the display unit while being spatially shifted so that they are successively displayed at their corresponding positions. Therefore, the input images can be displayed at high resolution, and image processing which requires high-speed processing can be constituted with inexpensive circuits by using a plurality of low-rate processing circuits.

### BRIEF DESCRIPTION OF THE DRAWINGS

FIG. 1 is a block diagram showing the outline constitution of the image display device according to the first embodiment of the present invention.

FIG. 2 is a schematic diagram of an input image for explaining the outline operation of image processing according to the first embodiment.

FIGS. 3(a) and 3(b) are also schematic diagrams of image segments.

FIGS. 4(a) and 4(b) are also schematic diagrams of an enlarged image segments.

FIGS. 5(a) and 5(b) are diagrams for explaining the process in which the enlarged image segments of FIGS. 4(a) and 4(b) are formed from the image segments of FIGS. 3(a) and 3(b).

FIGS. 6(a) and 6(b) are also schematic diagrams of output images.

FIG. 7 is a block diagram showing the outline constitution of image display device according to the second embodiment of the present invention.

FIG. 8 is also a block diagram showing the outline constitution of image display device according to the third embodiment of the present invention.

FIG. 9 is a schematic diagram of an input image for explaining the outline operation of image processing according to the third embodiment.

FIGS. 10(a) to 10(d) are also schematic diagrams of image segments.

FIGS. 11(a) to 11(d) are also schematic diagrams of enlarged image segments.

FIGS. 12(a) to 12(d) are also schematic diagrams of output images.

FIG. 13 is a block diagram showing the outline constitution of image display device according to the fourth embodiment of the present invention.

FIG. 14 is a perspective view showing the outline constitution and the pixel shifting operation of the pixel shifting unit of FIG. 13.

FIG. 15 is a diagram showing the image division processing by the image division unit of FIG. 13.

FIG. 16 is a diagram showing the image enlargement processing by the image enlargement unit of FIG. 13.

FIG. 17 is a diagram showing the output image formation processing by the output image formation unit of FIG. 13.

FIG. 18 is also a diagram showing the output image formation processing by the output image formation unit of FIG. 13.

FIG. 19 is a timing diagram showing the operation of the image display unit of FIG. 13.

FIG. 20 is a diagram for explaining the fifth embodiment of the present invention.

FIG. 21 is a block diagram showing the outline constitution of the image display device according to the sixth embodiment of the present invention.

FIG. 22 is a diagram showing the image division processing by the image division unit of FIG. 21.

FIG. 23 is a diagram showing the image diminishing processing by the image diminishing unit of FIG. 21.

FIG. 24 is a diagram showing the output image formation processing by the output image formation unit of FIG. 21.

FIG. 25 is a diagram showing the display of the output image on the image display element of FIG. 21.

FIG. 26 is a block diagram showing the outline constitution of the image display device according to the seventh embodiment of the present invention.

FIG. 27 is a diagram showing relation between the display area of the image display unit of FIG. 26 and the pixel shifting display area of the output image.

FIG. 28 is a diagram showing the superimpose example according to the seventh embodiment.

FIG. 29 is a block diagram showing the outline constitution of the image display device according to the eighth embodiment of the present invention.

FIG. 30 is a diagram showing the superimpose example according to the eighth embodiment.

### DESCRIPTION OF THE PREFERRED EMBODIMENTS

The embodiment of the present invention will be described below with reference to the drawings.

### First Embodiment

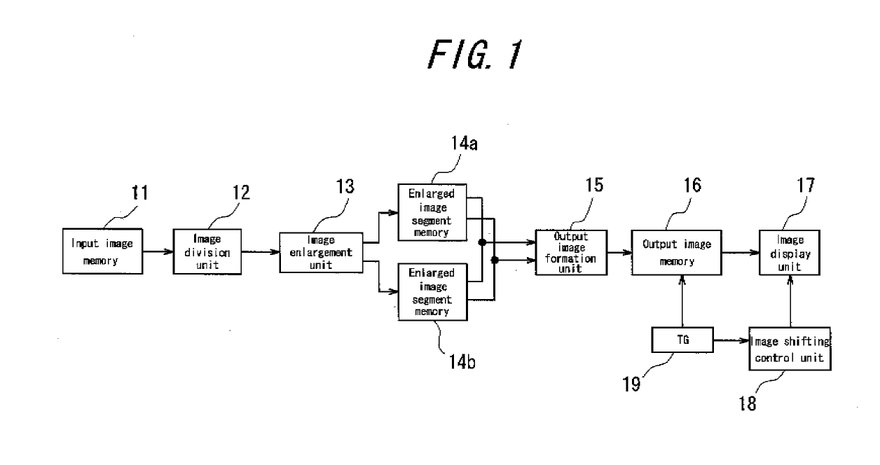

FIG. 1 is a block diagram showing the outline constitution of the image display device according to the first embodiment of the present invention. This image display device comprises an input image memory 11, an image division unit 12, an image enlargement unit 13, enlarged image segment memories 14a and 14b, an output image formation unit 15, an output image memory 16, an image display unit 17, a pixel shifting control unit 18, and a timing generator (TG) 19.

The embodiment of the present invention is carried out to divide an HD-resolution input image of 1,440 horizontal pixels×720 vertical lines into two segments partly overlapping each other, to enlarge the respective numbers of the pixels in the horizontal direction to two times, and from these two enlarged image segments to form two output images corresponding to the first display position and the second display position shifted ½ pixel pitch relative to the pixel pitch in the horizontal direction at the image display unit 17 of the actual resolution of 1,440×720. These two output images are displayed shifted ½ pixel pitch or shifted with two points pixel shifting at the image display unit 17, thereby obtaining images of a higher resolution.

For this purpose, first of all, from the input image stored in the input image memory 11, the first horizontal pixel to 722nd pixel and the first vertical line to 720 line are read out in the image division unit 12, and these are output to the image enlargement unit 13 as a first image segment of 722×720 pixels. In the image enlargement unit 13, by well-known pixel interpolation method, for example, the linear interpolation or the interpolation by bicubic function, the number of pixels of the first image segment in the horizontal direction is enlarged to two times and is memorized in the enlarged image segment memory 14a as a first enlarged image segment of 1,444×720 pixels.

Subsequently, from the input image stored in the input image memory 11, 718th horizontal pixel to 1,440th pixel and first vertical line to 720 line are read out so as to partly overlap each other in the image division unit 12, and these are output to the image enlargement unit 13 as a second image segment of 722×720 pixels In the image enlargement unit 13, the number of the pixels in the horizontal direction is enlarged to two times and is memorized in the enlarged image segment memory 14b as a second enlarged image segment of 1,444×720 pixels in the similar manner to the first enlarged image segment.

When the first enlarged image segment and second enlarged image segment have been stored in the enlarged image segment memories 14a and 14b, respectively, the odd numbered pixels of the first enlarged image segment and the second enlarged image segment are taken out so as to permit the overlapping segments to be successive in the output image formation unit 15 so that a first output image of 1,440×720 pixels corresponding to the HD resolution image display unit 17 is formed and memorized in the output image memory 16.

This first output image memorized in the output image memory 16 is displayed by the image display unit 17 at the first display position by controlling the pixel shifting control unit 18 and the output image memory 16 by means of the TG 19.

Subsequently, from the first enlarged image segment and second enlarged image segment memorized in the enlarged image segment memories 14a and 14b, the even numbered pixels are taken out so as to permit the overlapping segments to be successive in the output image formation unit 15 so that a second output image of 1,440×720 pixels corresponding to the HD resolution image display unit 17 is formed and then memorized in the output image memory 16,

This second output image memorized in the output image memory 16 is displayed by image display unit 17 at a second display position shifted ½ pitch in the horizontal direction from the first display position by controlling the pixel shifting control unit 1 8 and output image memory 16 by means of the TG 19.

Moreover, the pixel shifting control unit 18 may be of well-known constitution, for example, may be constructed that a liquid crystal panel and a double refraction board are disposed on the display side of the image display unit 17 and voltage is selectively applied to the liquid crystal panel so that the display pixel position of the image display unit 17 is optically shifted, or that the whole image display unit 17 is directly displaced by piezoelectric device so that the display pixel position is mechanically shifted.

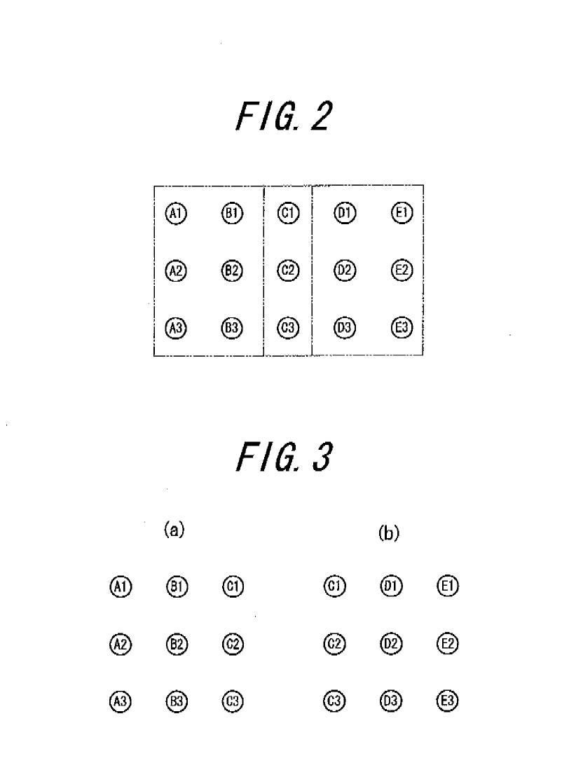

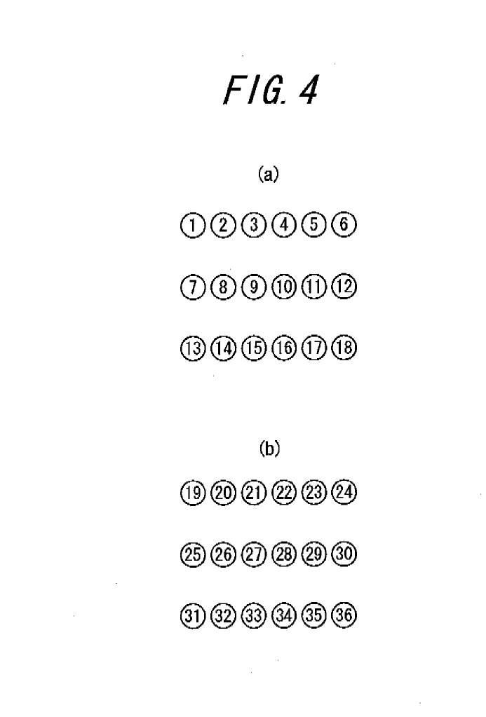

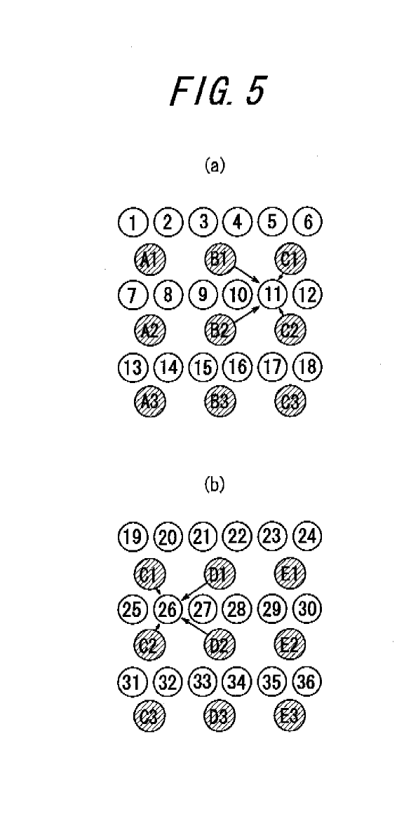

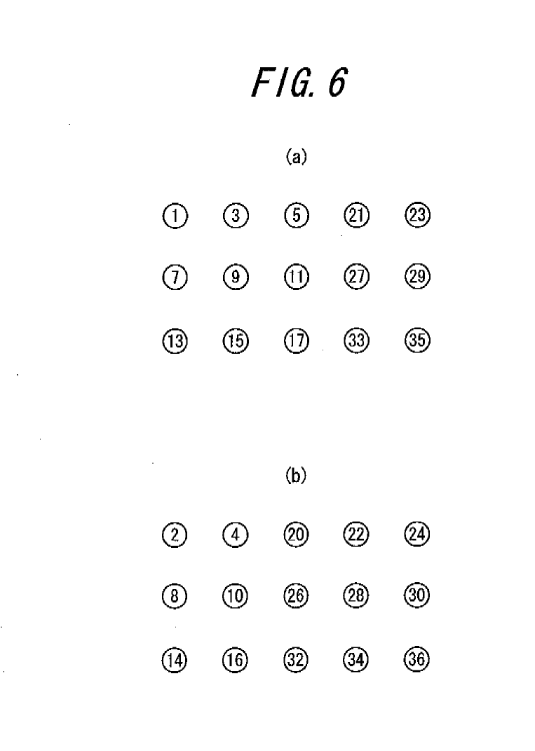

FIGS. 2 to 6 are explaining the outline of the operation for processing images according to the present embodiment, FIG. 2 is a schematic diagram of an input image, and FIGS, 3(a) and 3(b) are schematic diagrams of image segments. FIGS. 4(a) and 4(b) are schematic diagrams of enlarged image segments. FIG. 5 is a diagram for explaining the process in which the enlarged image segments are formed from the image segments, and FIGS. 6(a) and 6(b) are schematic diagrams of output images. Here, as shown in FIG. 2, the input image to be stored in the input image memory 11 is simplified to be five horizontal pixels A to E and three vertical lines, i.e. amounts to a total of 15 pixels. In FIGS. 2 and 3, suffix “1” is added to the first line pixel, suffix “2” to the second, and suffix “3” to the third, respectively. However, these suffixes will be omitted in the following description when the line is not identified.

First, in the image division unit 12, by controlling the readout of the input image memory 11, the input image shown in FIG. 2 is divided into two segments in a manner that the central pixels C overlap each other to form a first image segment consisting of a total of 9 pixels, that is three horizontal pixels A to C and 3 vertical lines as shown in FIG. 3(a). The number of the pixels in the horizontal direction of this first image segment is then enlarged to two times in image enlargement unit 13 to form a first enlarged image segment of six horizontal pixels×three vertical lines (first pixel to 18th pixel) as shown in FIG. 4(a).

Subsequently, in the image division unit 12, by controlling the readout of input image memory 11, a second image segment consisting of a total of nine pixels, that is, three horizontal pixels C to E and three vertical lines as shown in FIG. 3(b) is formed from input image shown in FIG. 2. The number of horizontal pixels of this second image segment is then enlarged to two times in the image enlargement unit 13 to form a second enlarged image segment of six horizontal pixels×3 vertical lines (19th pixel to 36th pixel) as shown in FIG. 4(b) as is the case with the first image segment.

Now, one example of a method to form the first enlarged image segment shown in FIG. 4(a) from the first image segment shown in FIG. 3(a) will be explained below with reference to FIG. 5(a). FIG. 5(a) shows the relation between the positions of the pixels of the first image segment, A1, B1, C1, A2, B2, C2, A3, C3, and C3, and positions of the pixels of the first enlarged image segment, 1, 2, 3, 4, 5, 6, 7, 8, 9, 10, 11, 12, 13, 14, 15, 16, 17, and 18. For example, the pixel 11 is formed from the pixels around it, B1, C1, B2, and C2 by interpolation. The pixel value of this pixel 11 is decided by the products of these pixels, B1, Cl, B2, and C2, and the weighting corresponding to each of the pixels, using four points interpolation method.

Similarly, one example of a method to form the second enlarged image segment shown in FIG. 4(b) from the second image segment shown in FIG. 3(b) will be explained below with reference to FIG. 5(b). FIG. 5(b) shows the relation between the positions of the pixels of the second image segment, C1, D1, E1, C2, D2, E2, C3, D3, and E3, and the positions of the pixels of the second enlarged image segment, 19, 20, 21, 22, 23, 24, 25, 26, 27, 28, 29, 30, 31, 32, 33, 34, 35, and 36. For example, the pixel 26 is formed from the pixels around it, C1, D2, C2 and D2 by interpolation. The pixel value of this pixel 26 is decided by the products of these pixels, C1, D1, C2, and D2, and the weighting corresponding to each of the pixels, using four points interpolation method.

The pixel interpolation method is not limited to the above examples. Appropriate interpolation methods can be used depending on the circuit scale and the image. For example, in the above example, the pixel used for interpolation is 2×2 pixel in proximity, but the interpolation pixel value can be decided based on bicubic interpolation method which uses circumferential 4×4 pixel.

Next, in the output image formation unit 15, the odd numbered pixels of the first enlarged image segment and the second enlarged image segment as shown in FIG. 4(a) and (b) are taken out so as to permit the overlapping segments to be successive to form a first output image of pixels (here, 5×3 pixels) corresponding to the image display unit 17 as shown in FIG. 6(a). Then the first output image is displayed by the image display unit 17 at the first display position under control of the pixel shifting control unit 18. In other words, here, the first output image shown in FIG. 6(a) is formed by 5×3 pixels wherein the first line includes the first, third and fifth pixels of the first enlarged image segment as shown in FIG. ⁴(a) and the 21st and 23rd pixels of the second enlarged image segment as shown in FIG. 4(b), the second line includes the 7th, 9th, and 11th pixels of the first enlarged image segment as shown in FIG. 4(a) and the 27th and 29th pixels of the second enlarged image segment as shown in FIG. 4(b), and the third line includes the 13th, 15th, and 17th pixels of the first enlarged image segment as shown in FIG. 4(a) and the 33rd and 35th pixels of the second enlarged image segment as shown in FIG. 4(b). The first output image is displayed by the image display unit 17 at the first display position under control of the pixel shifting control unit 18.

Subsequently, in the output image formation unit 15, similarly, the even numbered pixels of the first enlarged image segment and the second enlarged image segment as shown in FIG. 4(a) and 4(b) are taken out so as to permit the overlapping segments to be successive to form a second output image of pixels (5×3 pixels) corresponding to the image display unit 17 as shown in FIG. 6(b). The formed second output image is displayed by the image display unit 17 under control of the pixel shifting control unit 8, at the second display position, ½ pixel pitch shifted in the horizontal direction from the first display position. In other words, here, the second output image shown in FIG. 6(b) is formed by 5×3 pixels wherein the first line includes the second and fourth pixels of the first enlarged image segment as shown in FIG. 4(a) and the 20th, 22nd and 24th pixels of the second enlarged image segment as shown in FIG. 4(b), the second line includes the 8th and 10th pixels of the first enlarged image segment as shown in FIG. 4(a) and the 26th, 28th, and 30th pixels of the second enlarged image segment as shown in FIG. 4(b), and the third line includes the 14th and 16th pixels of the first enlarged image segment as shown in FIG. 4(a) and the 32nd , 34th, and 36th pixels of the second enlarged image segment as shown in FIG. 4(b). The second output image is displayed by the image display unit 17 under control of the pixel shifting control unit 18 at the second display position, ½ pixel pitch shifted in the horizontal direction from the first display position.

As mentioned above, according to the present embodiment, an HD-resolution input image of 1,440×720 pixels is divided into 2 segments in the horizontal direction in a manner partly overlapping each other to form two image segments of 722×720 pixels. Then the numbers of the pixels of these image segments in the horizontal direction are enlarged to two times to form two enlarged image segments of 1,440×720 pixels, respectively. Then from these two enlarged image segments, two output images of 1,440×720 pixels are formed corresponding to the first and second display positions ½ pitch shifted relative to the horizontal pixel pitch of the image display unit 17 of the real resolution of 1,440×720 pixels. Further, these two output images are displayed after being shifted with two point pixel shifting in the image display unit 17, thereby enabling an HD-resolution input image of 1,440×720 to be displayed at the resolution two times the original resolution in the horizontal direction by the use of the image display unit 17 of the real resolution of 1,440×720 pixels. Moreover, after the input image of 1,440×720 pixels is divided in the horizontal direction, the numbers of the pixels in the horizontal direction are processed to enlarge to two times, and these two enlarged image segments are used to form two output images at different display positions, thereby enabling images to display inexpensively in high-speed processing.

### Second Embodiment

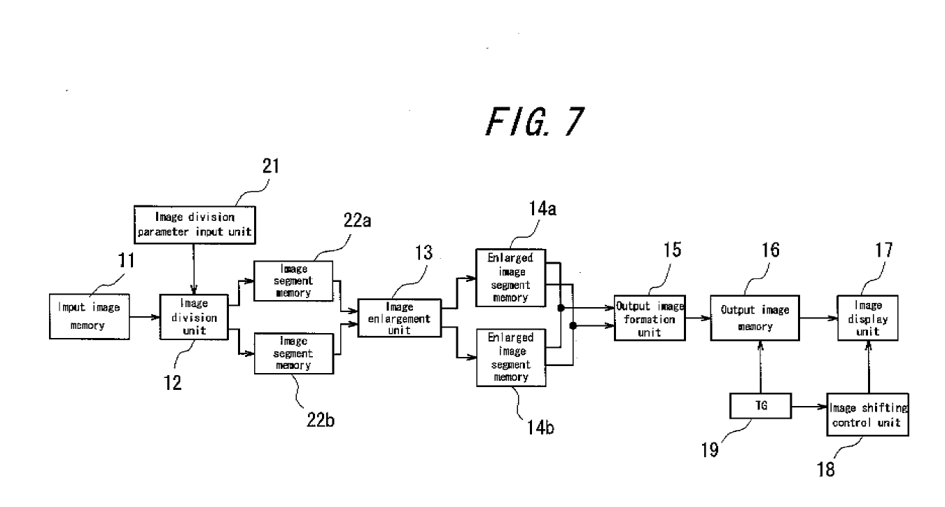

FIG. 7 is a block diagram showing the outline constitution of an image display device according to the second embodiment of the present invention.

According to the present embodiment, added to the image display device shown in FIG. 1 are an image division parameter input unit 21 for setting the width of the overlapping region of two image segments to be divided by the image division unit 12, and image segment memories 22a and 22b for separately memorizing the two image segments divided. In other word, the readout of input image memory 11 is controlled by the image division unit 12 on the basis of the image division parameter set in the image division parameter input unit 21 to divide the input image into a first image segment and a second image segment, and these first and second image segments are separately memorized in the image segment memories 22a and 22b. In the image enlargement unit 13, the numbers of pixels in the horizontal direction of the first and second image segments memorized in the image segment memories 22a and 22b are enlarged to two times, respectively, and the enlarged image segments are memorized in the enlarged image segment memories 14a and 14b. Other constitutions and operations are substantially the same as those described in the first embodiment,

By providing the image division parameter input unit 21 in this manner, depending upon the pixel interpolation method used in the image enlargement unit 13, the overlapping region of image segments to be divided can be suitably set. Therefore, when forming an output image from the enlarged image segments with the numbers of pixels in the horizontal direction enlarged in the image enlargement unit 13, the unnaturalness of the joint of the two image segments divided in the image division unit 12 can be eliminated. Moreover, as the image segment memories 22a and 22b are provided to memorize the image segments divided into two segments in the image division unit 12, there is an advantage that the adjustment of timing of image processing can be easily effected.

### Third Embodiment

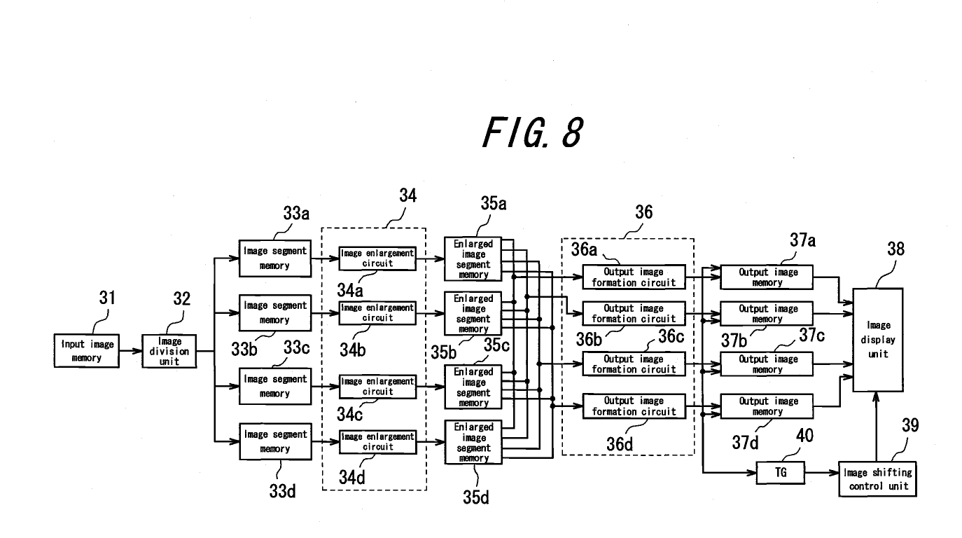

FIG. 8 is a block diagram showing the outline constitution of the image display device according to the third embodiment of the present invention. This image display device comprises an input image memory 31, an image division unit 32, image segment memories 33a to 33d, an image enlargement unit 34, enlarged image segment memories 35a to 35d, an output image formation unit 36, output image memories 37a to 37d, an image display unit 38, an pixel shifting control unit 39, and a timing generator (TG) 40. Furthermore, the image enlargement unit 34 has image enlargement circuits 34a to 34d, and the output image formation unit 36 has output image formation circuits 36a to 36d.

According to the present embodiment, an HD-resolution input image of 1,920 horizontal pixels×1,080 vertical lines is divided in the horizontal and vertical directions into four segments partly overlapping one another, and the numbers of pixels in the horizontal and vertical directions are enlarged to two times, respectively. From these four enlarged image segments, four output images are formed, which correspond to the first to fourth display positions shifted ½ pixel pitch relative to pixel pitches in the horizontal, vertical, and diagonal directions of the image display unit 38 of the real resolution of 1,920×1,080 pixels, and these four output images are displayed with four point pixel shifting in the image display unit 38, thereby obtaining images of a high resolution.

For this purpose, first, by controlling the readout of the input image memory 31 by the image division unit 32, first horizontal pixel to 964th pixel and first vertical line to 544th line of the input image stored in the input image memory 31 are memorized in the image segment memory 33a as a first image segment, and 957th horizontal pixel to 1,920th pixel and first vertical line to 544th line are readout as second image segment and memorized in the image segment memory 33b. Further, first horizontal pixel to 964th pixel and 537th vertical line to 1,080th line are memorized in the image segment memory 33c as a third image segment, and 957th horizontal pixel to 1,920th pixel and 537th vertical line to 1,080th line are readout as a fourth image segment and memorized in the image segment memory 33d.

The numbers of pixels in the horizontal and vertical directions of the first image segment memorized in the image segment memory 33a are enlarged to two times, respectively, in the corresponding image enlargement circuit 34a by the well-known pixel interpolation method, and the enlarged image segment is memorized in the corresponding enlarged image segment memory 35a as a first enlarged image segment of 1,928×1,088 pixels. In the same way, the numbers of pixels in the horizontal and vertical directions of the second to fourth image segments memorized in the image segment memories 33b to 33d are enlarged to two times, respectively, in the corresponding image enlargement circuits 34b to 34d and the enlarged image segments are memorized in the corresponding enlarged image segment memories 35b to 35d as second to fourth enlarged image segments of 1,920×1,088 pixels.

When the first to fourth enlarged image segments have been memorized, respectively, in the enlarged image segment memories 35a to 35d, a first output image of 1,920×1,080 pixels corresponding to the first display position by the image display unit 38 is formed in the out put image formation circuit 36a from the first to fourth enlarged image segments memorized in the enlarged image segment memories 35a to 35d in a manner that the overlapping regions become successive, and the formed first output image is then memorized in the corresponding output image memory 37a. In the same way, in the output image formation circuits 36b to 36d, second to fourth output images of 1,920×1,080 pixels corresponding to the second to fourth display positions shifted ½ pixel pitch in the horizontal, vertical and diagonal directions from the first display position by the image display unit 38 are formed from the first to fourth enlarged image segments memorized in the enlarged image segment memories 35a to 35d, in a manner that the overlapping regions become successive, and the formed second to fourth output images are then memorized in the corresponding output image memories 37b to 37d.

These first to fourth output images memorized in the output image memories 37a to 37d are displayed by the image display unit 38 at first to fourth display positions with pixels being shifted by controlling the pixel shifting control unit 39 and the output image memories 37a to 37d by the TG 40. Moreover, the pixel shifting control unit 39 is constituted so as to shift the display pixel positions of image display unit 38 mechanically or optically, in the same way as in the embodiment mentioned above.

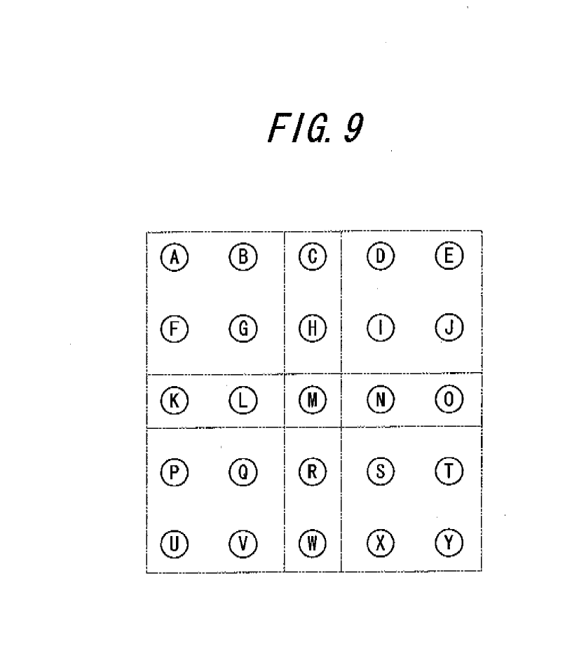

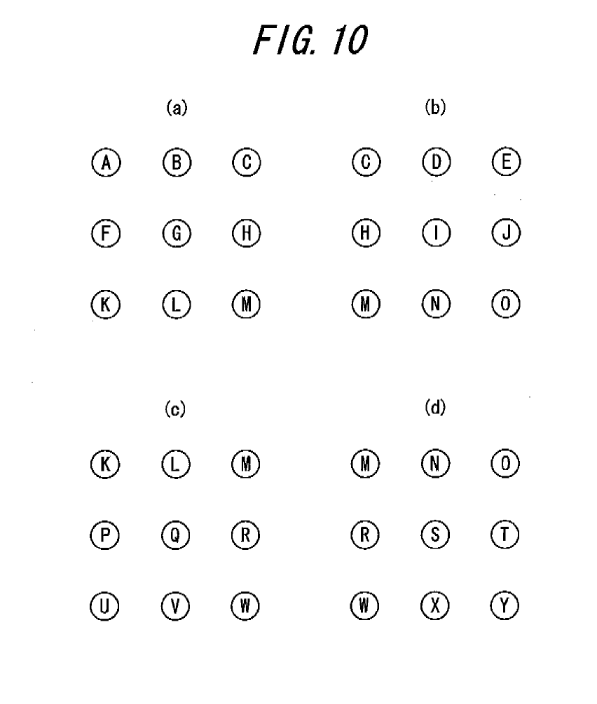

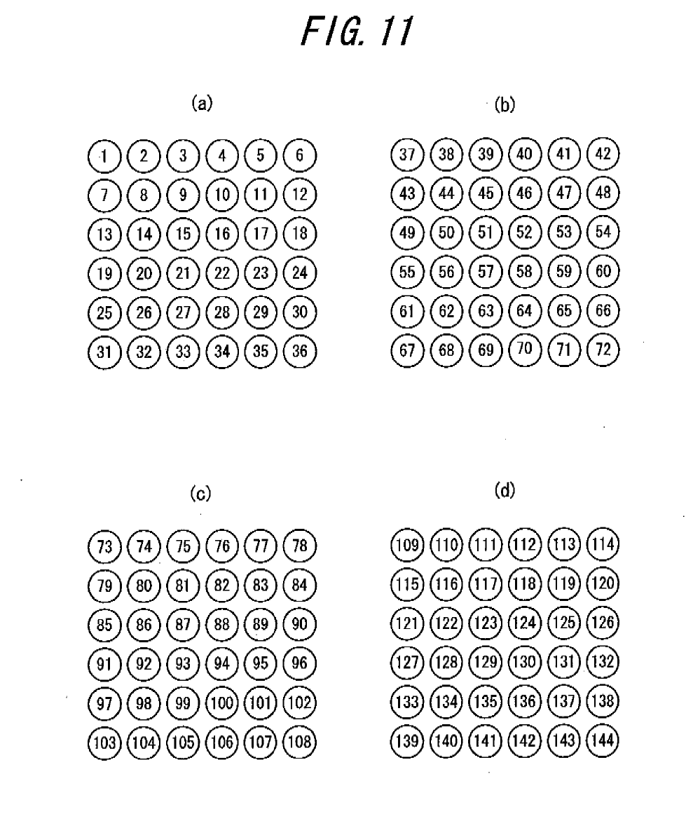

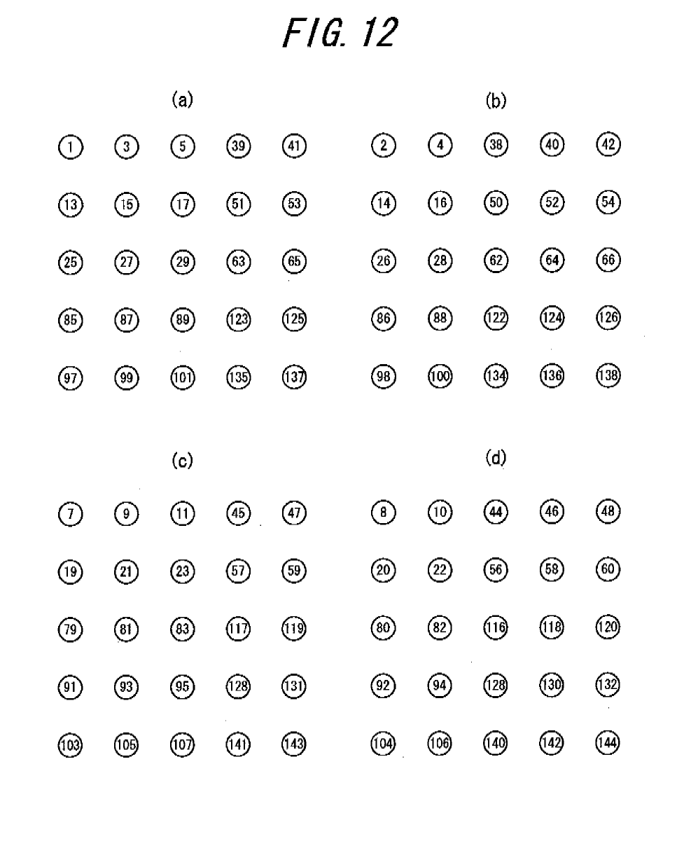

FIG. 9 to FIGS. 12(a)-12(d) are schematic diagrams explaining the outline operation of image processing according to the present embodiment . FIG. 9 is a schematic diagram of an input image, and FIGS. 10(a) to 10(d) are schematic diagrams of image segments. FIGS. 11(a) to 11(d) are schematic diagrams of enlarged image segments, and FIGS. 12(a) to 12(d) show schematic diagrams of output images. Here, the input image to be stored in the input image memory 31 is simplified by a total of 25 pixels A to Y, that is, five horizontal pixels and five vertical lines as shown in FIG. 9.

First, the readout of the input image memory 11 is controlled at the image division unit 32 so that the input image shown in FIG. 9 is divided into first to fourth image segments partly overlapping one another as shown in FIGS. 10(a) to 10(d). More specifically, the first image segment is of 3×3 pixels consisting of first to third pixels of first to third lines (A, B, C; F, G, H; K, L, M) as shown in FIG. 10(a), and the second image segment is of 3×3 pixels consisting of third to fifth pixels of first to third lines (C, D, B; H, I, J; M, N, O) as shown in FIG. 10(b). The third image segment is of 3×3 pixels consisting of first to third pixels of third to fifth lines (K, L, M; P, Q, R; U, V, W) as shown in FIG. 10(c), and the fourth image segment is of 3×3 pixels consisting of third to fifth pixels of third to fifth lines (M, N, O; R, S, T; W, X, Y) as shown in FIG. 10(d),

In the image enlargement circuits 34a to 34d, the numbers of pixels in the horizontal and vertical directions of the corresponding first to forth image segments are enlarged to two times to form first to fourth enlarged image segments of 6×6 pixels, respectively, as shown in FIGS. 11(a) to 11(d). Here, the first enlarged image segment is shown by first to 36th pixels as shown in FIG. 11(a), and the second enlarged image segment is shown by 37th to 72nd pixels as shown in FIG. 11(b). The third enlarged image segment is shown by 73rd to 10th pixels as shown in FIG. 11(c), and the fourth enlarged image segment is shown by 109th to 144th pixels as shown in FIG. 11(d).

In the output image formation circuits 36a to 36d, first to fourth output images as shown in FIGS. 12(a) to (d) are formed from the first to fourth enlarged image segments in a manner such that the overlapping regions become successive, and the formed first to fourth output images correspond to first to fourth display positions ½ pitch shifted, respectively, relative to the pixel pitches in the horizontal, vertical and diagonal directions in the image display unit 38 of a real resolution of 5×5.

More specifically, here, the first output image is formed by 5×5 pixels as shown in FIG. 12(a) which include a first line consisting of first, third and fifth pixels of the first enlarged image segment shown in FIG. 11(a) and 39th and 41st pixels of the second enlarged image segment shown in FIG. 11(b), a second line consisting of 13th, 15th and 17th pixels of the first enlarged image segment shown in FIG. 11(a) and 51st and 53rd pixels of the second enlarged image segment shown in FIG. 11(b), a third line consisting of 25th, 27th and 29th pixels of the first enlarged image segment shown in FIG. 11(a) and 63rd and 65th pixels of the second enlarged image segment shown in FIG. 11(b), a fourth line consisting of 85th, 87th and 89th pixels of the third enlarged image segment shown in FIG. 11(c) and 123rd, and 125th pixels of the fourth enlarged image segment shown in FIG. 11(d), and a fifth line consisting of 97th, 99th and 101st pixels of the third enlarged image segment shown in FIG. 11(c) and 135th and 137th pixels of the fourth enlarged image segment shown in FIG. 11(d).

Similarly, the second output image is formed by 5×5 pixels as shown in FIG. 12(b) which include a first line consisting of second and fourth pixels of the first enlarged image segment shown in FIG. 11(a) and 38th, 40th and 42nd pixels of the second enlarged image segment shown in FIG. 11(b), a second line consisting of 14th and 16th pixels of the first enlarged image segment shown in FIG. 11(a) and 50th, 52nd and 54th pixels of the second enlarged image segment shown in FIG. 11(b), a third line consisting of 26th and 28th pixels of the first enlarged image segment shown in FIG. 11(a) and 62nd, 64th and 66th pixels of the second enlarged image segment shown in FIG. 11(b), a fourth line consisting of 86th and 88th pixels of the third enlarged image segment shown in FIG. 11(c) and 122nd, 124th and 126th pixels of the fourth enlarged image segment shown in FIG. 11(d), and a fifth line consisting of 98th and 100th pixels of the third enlarged image segment shown in FIG. 11(c) and 134th, 136th and 138th pixels of the fourth enlarged image segment shown in FIG. 11(d).

The third output image is formed by 5×5 pixels as shown in FIG. 12(c) which include a first line consisting of 7th, 9th and 11th of the first enlarged image segment shown in FIG. 11(a) and 45th and 47th pixels of the second enlarged image segment shown in FIG. 11(b), a second line consisting of 19th, 21st and 23rd pixels of the first enlarged image segment shown in FIG. 11(a) and 57th and 59th pixels of second enlarged image segment shown in FIG. 11(b), a third line consisting of 79th, 81st and 83rd pixels of the third enlarged image segment shown in FIG. 11(c) and 117th and 119th pixels of the fourth enlarged image segment shown in FIG. 11 (d), a fourth line consisting of 91st, 93rd and 95th pixels of the third enlarged image segment shown in FIG. 11(c) and 129th and 131st pixels of fourth enlarged image segment shown in FIG. 11(d), and a fifth line consisting of 103rd, 105th and 107th pixels of the third enlarged image segment shown in FIG. 11(c) and 141st and 143rd pixels of the fourth enlarged image segment shown in FIG. 11 (d).

Similarly, the fourth output image is formed by 5×5 pixels as shown in FIG. 12(d) which include a first line consisting of 8th and 10th pixels of the first enlarged image segment shown in FIG. 11(a) and 44th, 46th and 48th pixels of the second enlarged image segment shown in FIG. 11(b), a second line consisting of 20th and 22nd pixels of the first enlarged image segment shown in FIG. 11(a) and 56th, 58th and 60th pixels of the second enlarged image segment shown in FIG. 11(b), a third line consisting of 80th and 82nd pixels of the third enlarged image segment shown in FIG. 11(c) and 116th, 118th and 120th pixels of the fourth enlarged image segment shown in FIG. 11(d), a fourth line consisting of 92nd and 94th pixels of the third enlarged image segment shown in FIG. 11(c) and 128th, 130th and 132nd pixels of the fourth enlarged image segment shown in FIG. 11(d), and a fifth line consisting of 104th and 106th pixels of the third enlarged image segment shown in FIG. 11(c) and 140th,142nd and 144th pixels of the fourth enlarged image segment shown in FIG. 11(d).

These first to fourth output images formed in this way are displayed with pixels being shifted at first to fourth display positions by the image display unit 38 of the real resolution of 5×5.

According to the present embodiment as described above, the input image of 1,920×1,080 pixels is divided in the horizontal and vertical directions into four segments partly overlapping one another to form four image segments of 964×544 pixels, then the numbers of the pixels in the horizontal and vertical directions of these image segments are enlarged to two times to form four enlarged image segments of 1,920×1,080 pixels, respectively. Then, from these four enlarged image segments, four output images of 1,920×1,080 pixels are formed, corresponding to first to fourth display positions ½ pitch shifted relative to the pixel pitches in the horizontal, vertical and diagonal directions in the image display unit 38 of the real resolution of 1,920×1,080, then these four output images are displayed with four point pixel shifting in the image display unit 38, thereby enabling the HD-resolution input image of 1,920×1,080 pixels to be displayed at two times resolution in the horizontal and vertical directions by the image display unit 38 of the real resolution of 1,920×1,080. Moreover, after the input image of 1,920×1,080 pixels is divided into four segments, the numbers of the pixels in the horizontal and vertical directions are processed to enlarged to two times, then these four enlarged image segments are used to form the output images of first to fourth display positions different from one another equivalent to the four point pixel shifting, thereby forming output images inexpensively in high-speed processing.

### Fourth Embodiment

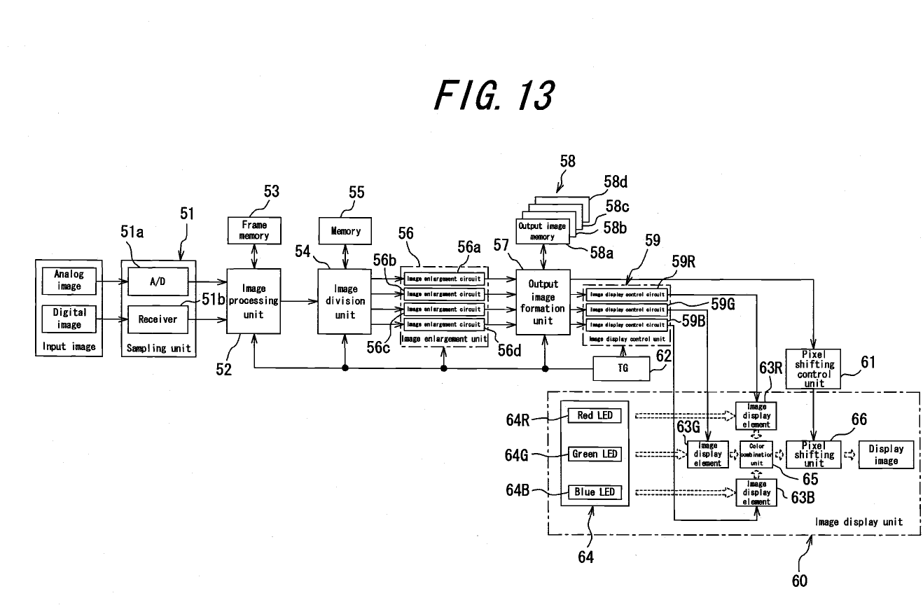

FIG. 13 is a block diagram showing the outline constitution of the image display device according to the fourth embodiment of the present invention. This image display device comprises a sampling unit 51, an image processing unit 52, a frame memory 53, an image division unit 54, a memory 55, an image enlargement unit 56 as an image scaling unit, an output image formation unit 57, an output image memory unit 58, an image display control unit 59, an image display unit 60, an pixel shifting control unit 61 and a timing generator (TG) 62.

The sampling unit 51 comprises Analog/Digital conversion circuit (A/D) 51a, and a receiver 51b adapted to, for example, HDMI (High-Definition Multimedia Interface), DVI (Digital Visual Interface), or HD-SDI (High Definition-Serial Digital Interface). When an analog image data is input to the sampling unit, the data is converted to the digital image data by the A/D conversion circuit 51a to be transmitted to the image processing unit 52. When a digital image data is input to the sampling unit, the data is sampled by the receiver 51b to be transmitted to the image processing unit 52.

The image processing unit operates image processing, such as frame rate conversion, IP conversion, color management, or invert γ, to the transmitted image data using the frame memory 53. The image data which is operated image processing is transmitted to the image division unit.

The image division unit 54 divides the processed image into a plurality of image segments partly overlapping each other using memory 55, and transmits each divided image segments to the image enlargement unit 56. In the present embodiment, the image division unit 54 divides the input image into four segments partly overlapping each other, and each divided image segments are enlarged in the image enlargement unit 56 to form enlarged image segments (scaling image segments).

For enlarging the divided image, four image enlargement circuits 56a to 56d whose number is corresponding to the image division number of the image division unit 54 are provided in the image enlargement unit 56. In these image enlargement circuits 56a to 56d, the input image segments are enlarged using a method such as linear interpolation, bicubic, NEDI (New Edge-Directed Interpolation), or Nearest Neighbor. The enlarged image segments are transmitted to the output image formation unit 57. Wherein, the image enlargement circuits 56a to 56d can be constituted using, for example, commodity type image processing IC whose maximum image size is about 2 M. The memories connected to the image enlargement circuits 56a to 56d respectively are omitted in the figure.

The output image formation unit 57 forms, from the four enlarged image segments output from the image enlargement circuits 56a to 56d of the image enlargement unit 56, output images corresponding to number of pixel shifting in the image display unit 60. The formed output images are stored in the output image memory unit 58. In the present embodiment, 4 pixel shifting is performed in the image display unit 60. Therefore, four output images are formed in the output image formation unit 57, and stored in the four output image memory 58a to 58d in the output image memory unit 58.

The output image formation unit 57 provides the output image stored in the output image memory 58a to 58d to the image display unit 60 through the image display control unit 59, while providing the display position information indicating the display position of the output image (shifting position) to the pixel shifting control unit 61.

In the present embodiment, the image display unit 60 is constituted with 3 plates of image display elements 63R, 63G and 63B corresponding to the R, G and B. Therefore, the image display control circuits 59R, 59G and 59B corresponding to the image display elements 63R, 63G and 63B are provided in the image display control unit 59. In these image display control circuits 59R, 59G and 59B, driving signals required in the corresponding image display elements 63R, 63G and 63B are formed, and the output image from the output images formation unit 57 are transmitted to the corresponding image display elements 63R, 63G and 63B.

The image display unit 60 comprises the above mentioned image display elements 63R, 63G and 63B, a light source unit 64, a color combination unit 65 and a pixel shifting unit 66. In the present embodiment, the image display elements 63R, 63G and 63B are constituted with transmissive LCD respectively, however, they can also be constituted with for example reflective LCOS or DMD. In addition, the light source 64 can be constituted with a white light source such as extra high pressure mercury lamp or xenon lamp for obtaining tricolored (red, green and blue) illumination, or three-color laser sources or LEDs, however, in the present embodiment, it is constituted with thee-color LED light sources of red LED 64R, green LED 64G and blue LED 64B.

In this way, while illuminating the image display elements 63R, 63G and 63B constituted with transmissive LCDs respectively with red LED 64R, green LED 64G and blue LED 64B respectively, the modulated images of respective colors are formed by writing the output images form the image display control circuits 59R, 59G and 59B on the image display elements 63R, 63G and 63B to spatially modulate the respective illuminated light.

The modulated images of respective colors formed by the red LED 64R, green LED 64G and blue LED 64B respectively are combined by the color combination unit 65 constituted with for example a color combination prism. The combined image is entered into the pixel shifting unit 66 as a linear polarized light whose modulation dimension is uniform, and selectively shifted the pixel for projected on such as a screen through projection optical system (omitted in the figure) to be observable by a observer.

The pixel shifting unit 66 is constituted with liquid crystal cells such as TN liquid crystal or ferroelectric liquid crystal as polarization rotating means, and birefringent plates composed of anisotropic crystal such as quartz, lithium niobate, rutile, calcite or Chile saltpeter as light path polarization means.

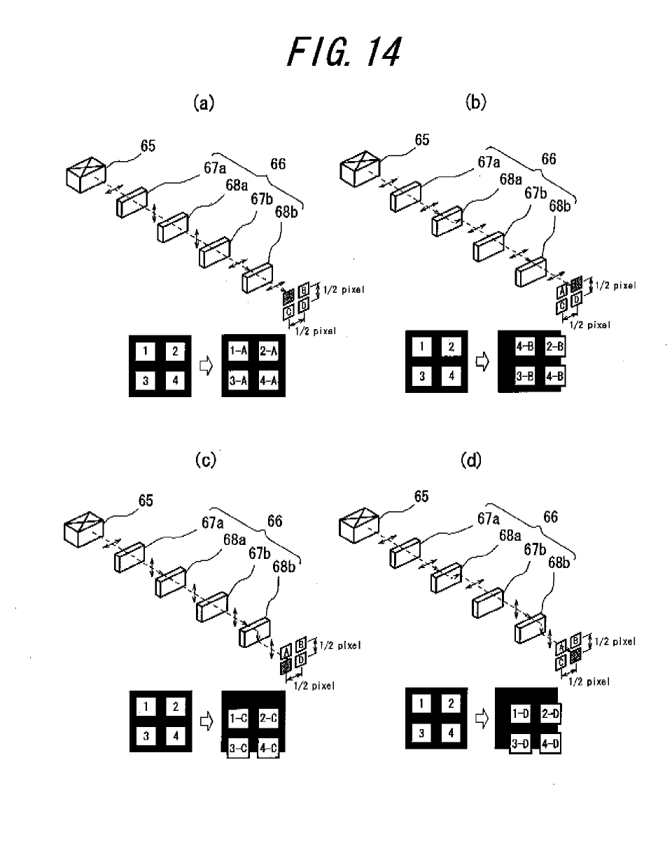

In the present embodiment, the pixel shifting unit 66 is constituted, for operating the four point pixel shifting, with liquid crystal cell 67a and birefringent plate 68a for horizontal pixel shifting, and liquid crystal cell 67b and birefringent plate 68b for vertical pixel shifting as shown in the FIG. 14. The liquid crystal cells 67a and 67b are ON/OFF controlled by the pixel shifting control unit 61 depending on the display pixel positions of output images. Wherein, the birefringent plate 68a shifts the polarized light with its polarization plane spreads horizontally (P polarized light) for ½ pixel pitch in the horizontal direction, and transmits the polarized light with its polarization plane spreads vertically (S polarized light), and the birefringent plate 68b shifts the S polarized light for ½ pixel pitch in the vertical direction, and transmits the P polarized light. In addition, the shift amount of the pixel can be arbitrarily configured by arranging the thickness of the birefringent plates 68a and 68b.

FIG. 14 (a) shows the state in which both the liquid crystal cells 67a and 67b are in OFF state. In this state, when the polarization plane of the modulated lights of R, G and B entering the liquid crystal cell 67a through the color combination unit 65 are P polarized light, these modulated lights are rotated 90° by liquid crystal cell 67a to be S polarized light and transmits the birefringent plate 68a without being pixel shifted. Moreover, they are rotated 90° by liquid crystal cell 67b to be P polarized light and transmits the birefringent plate 68b without being pixel shifted. Therefore, pixel position of the display image transmitted the pixel shifting unit 66 is same as the pixel position of the image before transmitting the unit. In other words, regarding one pixel, its pixel position is pixel position A.

FIG. 14 (b) shows the state in which both the liquid crystal cells 67a and 91b are in ON state. In this state, P polarized lights entering the liquid crystal cell 67a transmit the liquid crystal cell 67a without rotated the polarized plane and shifted the pixel by the birefringent plate 68a for ½ pixel pitch in horizontal direction. Moreover, they transmit the liquid crystal cell 67b as P polarized lights without rotated the polarized plane, so that they transmit the birefringent plate 68b without being pixel shifted. Therefore, pixel position of the display image transmitted the pixel shifting unit 66 is pixel position B shifted ½ pixel pitch in horizontal direction.

FIG. 14 (c) shows the state in which the liquid crystal cell 67a is in OFF state and liquid crystal cell 67b is in ON state. In this state, P polarized lights entering the liquid crystal cell 67a are rotated 90° by liquid crystal cell 67a to be S polarized light and transmit the birefringent plate 68a without being pixel shifted. Moreover, they transmit the liquid crystal cell 67b as S polarized lights, so that they are shifted for ½ pixel pitch in the vertical direction by the birefringent plate 68b. Therefore, pixel position of the display image transmitted the pixel shifting unit 66 is pixel position C shifted ½ pixel pitch in vertical direction.

FIG. 14 (d) shows the state in which the liquid crystal cell 67a is in ON state and liquid crystal cell 67b is in OFF state. In this state, P polarized lights entering the liquid crystal cell 67a transmits the liquid crystal cell 67a without rotated the polarized plane and shifted the pixel by the birefringent plate 68a for ½ pixel pitch in horizontal direction. Moreover, they are rotated 90° by liquid crystal cell 67b to be S polarized light and shifted the pixel by the birefringent plate 68b for ½ pixel pitch in vertical direction. Therefore, pixel position of the display image transmitted the pixel shifting unit 66 is pixel position D shifted ½ pixel pitch in both horizontal and vertical direction.

In addition, the constitution of the pixel shifting unit 66 is not limited to the above mentioned constitution using liquid crystal cells and birefringent plates, but can be constituted using prism (for example, refer to JP Patent 2709070), using galvanometer mirror (for example, refer to US 2005/0078056 A1) or using polarization means comprised of liquid crystal (for example, refer to JP 2003-279924 A).

In FIG. 13, TG62 forms signals required in each blocks and transmits them to the each blocks.

The specific example of the present embodiment is described below, in which input image is digital image signal of 720 p, and effective size of the image display elements 63R, 63G and 63B constituting the image display unit 60 are 1,280×720 pixels respectively. In addition, the input image of 720 p indicates that input frequency is 60 Hz, and 1 frame is comprised of a progressive image of 1,280'720 pixels.

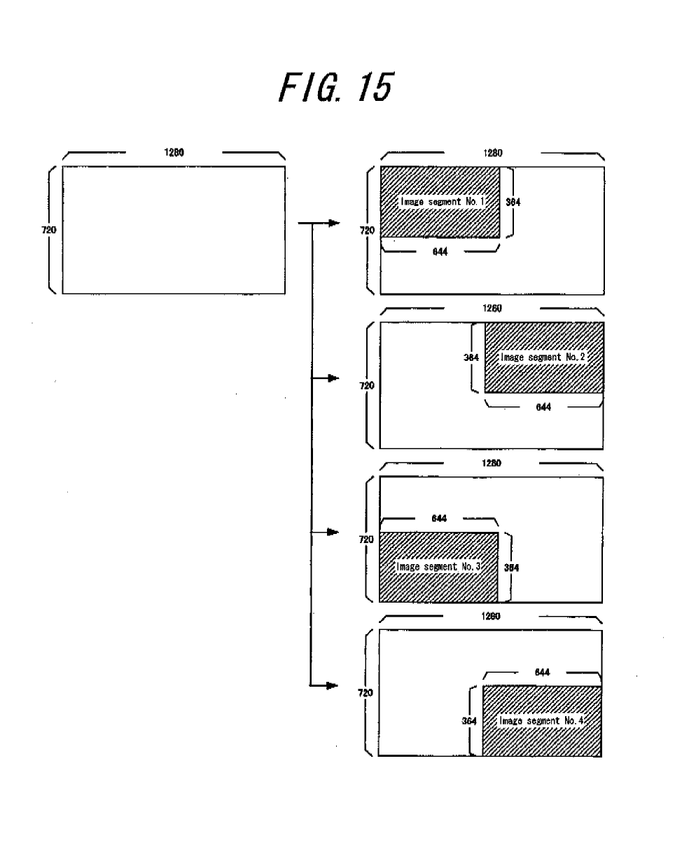

First, in the sampling unit 51, a digital image of 1,280×720 pixels is sampled from the input image and the sampled image is transmitted to the image processing unit 52. In the image processing unit 52, the transmitted image is sampled (operated frame rate conversion) so that it is synchronized with clock provided in the image display device. Subsequently, the sampled image (1,280×720 pixels) is transmitted to the image division unit 54 to be divided into four image segments No.1 to No.4 of 644×364 pixels partly overlapping each other as shown in FIG. 15,

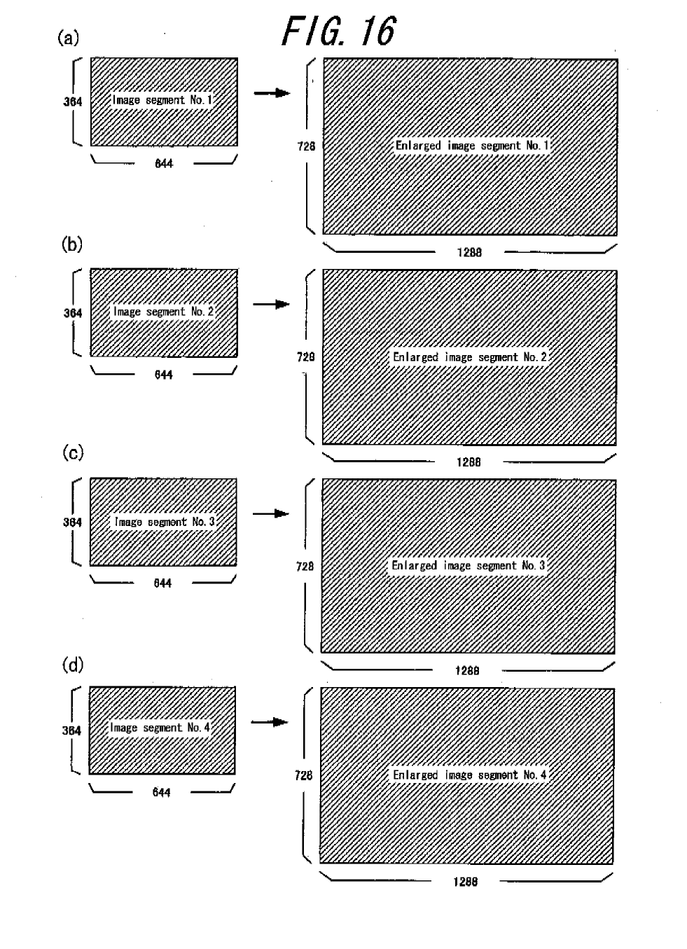

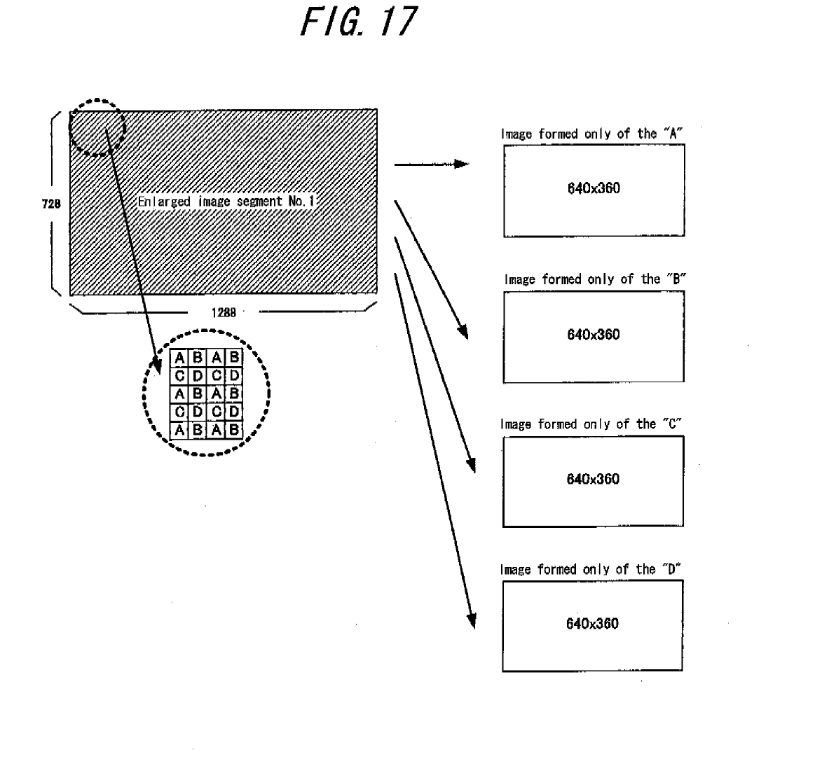

The four image segments No.1 to No.4 divided by the image division unit 54 are transmitted to the image enlargement unit 56 to be enlarged to form enlarged image segments No.1 to No.4 respectively, as shown in FIG. 16 (a) to (d). In the present embodiment, each image segments of 644×364 pixels are doubled the size by interpolating with bicubic method to form enlarged image segments of 1,288×728 pixels. The enlarged image segments No.1 to No.4 formed in the image enlargement unit 56 are transmitted to the output image formation unit 57.

The output image formation unit 57 forms, from the four enlarged image segments No.1 to No.4 transmitted from the image enlargement unit 56, output images No.1 to No.4 corresponding to number of pixel shifting in the image display unit 60. Therefore, assuming the odd columns (1st, 3rd, 5th . . . column) of odd lines (1st, 3rd, 5th . . . line) of the enlarged image segments as “A”, the even columns (2nd, 4th, 6th . . . column) of odd lines of the enlarged image segments as “B”, the odd columns of even lines (2nd, 4th, 6th . . . line) of the enlarged image segments as “C” and the even columns of even lines of the enlarged image segments as “D” as shown in FIG. 17, images formed only of the “A” of the respective enlarged image segments (644×364 pixels), images formed only of the “B” of the respective enlarged image segments (644×364 pixels), images formed only of the “C” of the respective enlarged image segments (644×364 pixels), images formed only of the “D” of the respective enlarged image segments (644×364 pixels) and images formed only of the “D” of the respective enlarged image segments (644×364 pixels) can be formed. However, in the present embodiment, images of 640×360 pixels are formed from the respective enlarged image segments so that respective overlaps are to be successive.

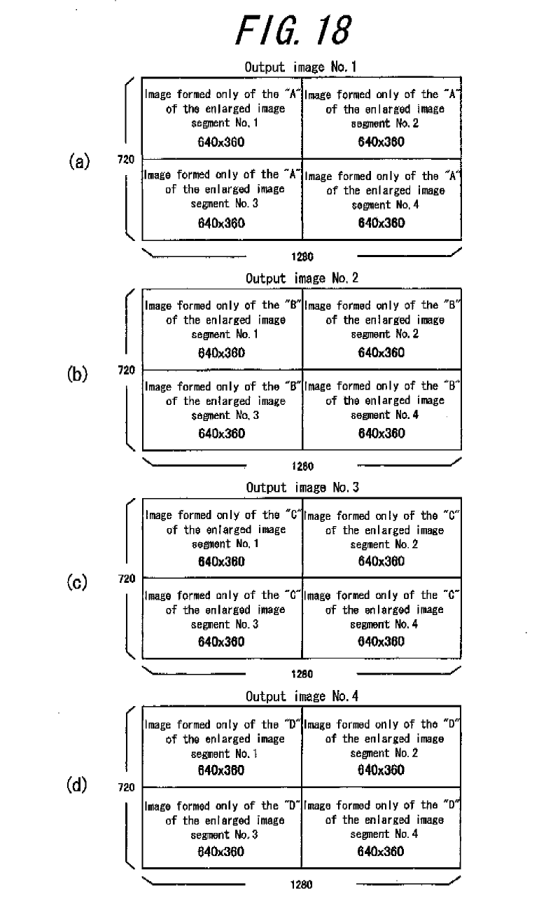

Subsequently, as shown in FIG. 18(a) to (d), images formed only of the “A” of the respective enlarged image segments (640×360 pixels), images formed only of the “B” of the respective enlarged image segments (640×360 pixels), images formed only of the “C” of the respective enlarged image segments (640×360 pixels) and images formed only of the “D” of the respective enlarged image segments (640×360 pixels) are combined to be output images No.1 to No.4 of 1,280×720 pixels so that overlap of respective enlarged images are to be successive, and these output images are stored in corresponding output image memories 58a to 58d. In addition, four output image memories 58a to 58d of 1,280×720 pixels are provided in the present embodiment, however, one memory of 2,560×1,440 pixels for one screen can be provided instead. In that case, the output images No.1 to No.4 of 1,280×720 pixels are formed when reading out the image form said memory of 2,560×1,440 pixels.

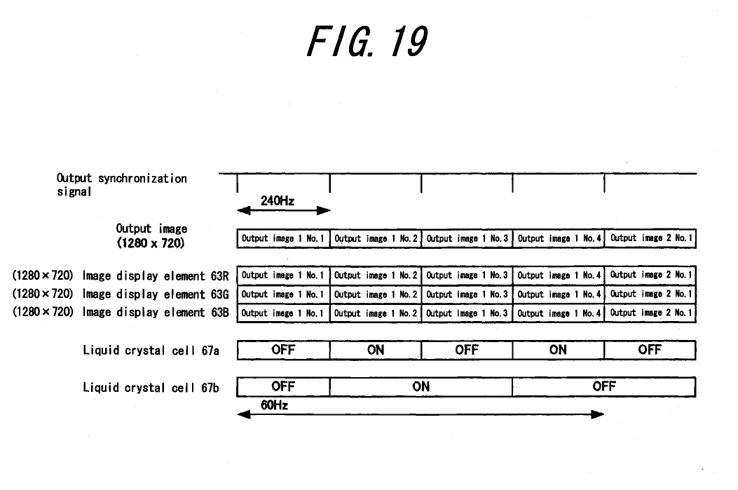

Subsequently, the output image formation unit 57 transmits the output image No.1 to No.4 to the output display control unit 59 at the moment shown in FIG. 19. The output image formation unit 57 also provides the pixel shifting control unit 61 with required display position information (in the present embodiment, it is a signal for turn liquid crystal cells 67a and 67b ON/OFF). The image display unit 60 displays the output image No.1 to No.4 with performing the 4 pixel shifting as shown in FIG. 14 (a) to (d).

In addition, the constitution of the image display unit 60 is not limited to the 3 plates constitution, but can be 4 plates constitution, 2 plates constitution or single plate constitution. Moreover, application of the present embodiment is not limited to the rear projection type or front projection type projectors, but it can be effectively applied to the FMD (Face Mount Display), HMD (Head Mount Display) or EVF (Electronic View Finder).

In the present embodiment, as described above, input image of 1,280×720 pixels is divided in horizontal and vertical direction into four image segments No 1 to No.4 of 644×364 pixels partly overlapping each other, then the number of pixels of the image segments No.1 to No.4 in horizontal and vertical direction are scaled into doubled size to form the enlarged image segments No.1 o No.4 of 1,288×728 pixels, subsequently, four output images No.1 to No.4 of 1,280×720 pixels selectively corresponding to the display position A to D ½ pixel pitch shifted in the horizontal, vertical and diagonal direction from the pixel pitch of the image display unit 60 whose practical resolution is 1,280×720 pixels are formed from the four enlarged image segments No.1 o No.4, and those four output images No.1 to No.4 are displayed in the image display unit 60 with four point pixel shifting, so that the input image of 1,280×720 pixels can be displayed with doubled horizontal and vertical resolution using the image display unit 60 whose practical resolution is 1,280×720 pixels. In addition, the device of the invention can be constituted in low price and to be able to perform high-speed processing, because the independent output images No.1 to No.4 of the display position A to D which are corresponding to those of four point pixel shifted images are formed from the four enlarged image segments acquired by dividing the input image of 1,280×720 pixels in horizontal and vertical direction into four image segments and scaling the number of pixels of the image segments in horizontal and vertical direction into doubled size.

### Fifth Embodiment

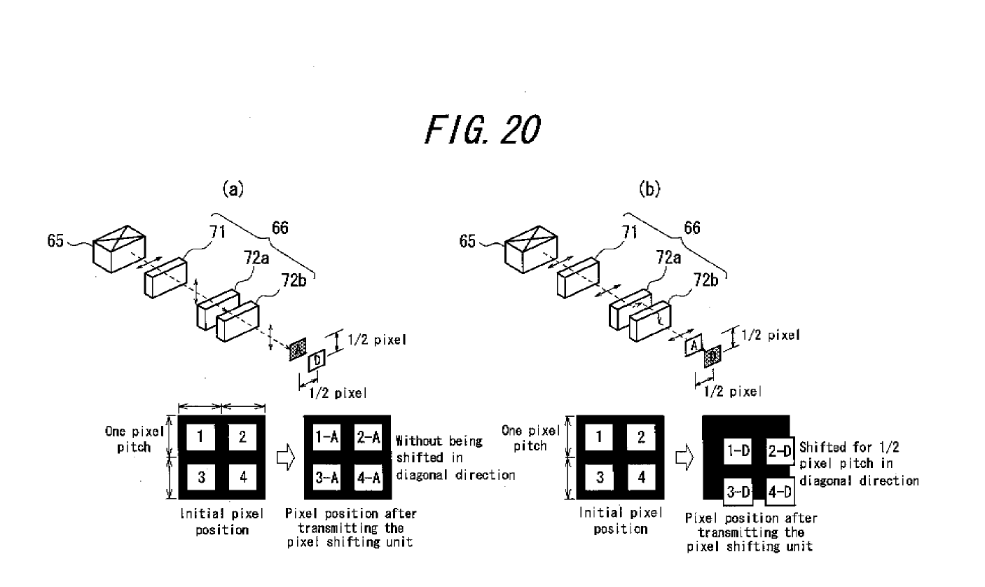

FIG. 20 is a diagram showing the fifth embodiment of the present invention. In the present embodiment, the pixel shifting unit 66 of the image display unit 60 is constituted so that it performs the two point pixel shifting that shifts the image for ½ pixel pitch in diagonal direction. Therefore, the pixel shifting unit 66 is constituted with liquid crystal cell 71 and two birefringent plates 72a and 72b as shown in FIG. 20, and pixel shifting unit 66 controls ON/OFF of the liquid crystal cell 71 by pixel shifting control unit 61 depending on the display pixel position of the output image. Wherein, the birefringent plate 72a shifts the polarized light with its polarization plane spreads horizontally (P polarized light) for ½ pixel pitch in the horizontal direction, and transmits the polarized light with its polarization plane spreads vertically (S polarized light), and the birefringent plate 72b shifts the P polarized light for ½ pixel pitch in the vertical direction, and transmits the S polarized light.

In addition, for performing two point pixel shifting in the diagonal direction, the output image memory unit 58 shown in FIG. 13 is constituted with output image memories 58a and 58d. Moreover, in the output image formation unit 57, output image No.1 is formed by combining the image (640×360 pixels) obtained by selecting the “A” shown in FIG. 17 from the four enlarged image segments No.1 to No.4 to be stored in the corresponding output image memory 58a, and output image No.4 is formed by combining the image (640×360 pixels ) obtained by selecting the “D” shown in FIG. 17 from the four enlarged image segments No.1 to No.4 to be stored in the corresponding output image memory 58d.

As described above, for displaying the output image No.1, as shown in FIG. 20(a), the liquid crystal cell 71 is in OFF state to convert the R, G, B modulated lights of the P polarized light passing color combination unit 65 into S polarized lights. Then, the modulated lights transmit the birefringent plates 72a and 72b without shifted the pixel, so that each pixels are displayed on the pixel position A identical to the initial pixel position. For displaying the output image No.4, as shown in FIG. 20(b), the liquid crystal cell 71 is in ON state to transmit the R, G, B modulated lights of the P polarized light passing color combination unit 65 as P polarized lights. Then, the modulated lights are shifted ½ pixel pitch in horizontal direction by the birefringent plate 72a, and are shifted ½ pixel pitch in diagonal direction by the birefringent plate 72b, so that each pixels are displayed on the pixel position D shifted ½ pixel pitch in diagonal direction from the initial pixel position. The other constitutions and the operations of the present embodiment are the same as those of the fourth embodiment.

According to the present embodiment, cost-down and low power consumption can be achieved because the number of the memories in the output image memory unit 58 can be reduced by performing two point pixel shifting. Therefore, the embodiment can particularly be applied on the EVFs of portable projectors or digital cameras running on batteries.

### Sixth Embodiment

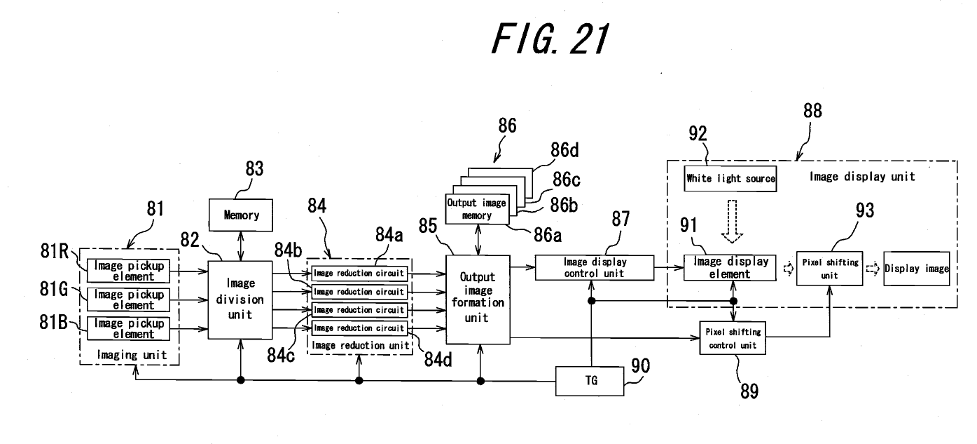

FIG. 21 is a block diagram showing the outline constitution of the image display device according to the sixth embodiment of the present invention. The present embodiment is applied to the EVFs of digital cameras and it comprises an imaging unit 81, an image division unit 82, a memory 83, an image reduction unit 84 as an image scaling unit, an output image formation unit 85, an output image memory unit 86, an image display control unit 87, an image display unit 88, an pixel shifting control unit 89, and a timing generator (TG) 90.

The imaging unit 81 is constituted with 3 plates of image pickup elements 81R, 81G and 81B corresponding to the R, G and B. The respective image pickup elements 81R, 81G and 81B can be constituted with CMOS sensor or CCD. The image pickup elements of the present embodiment is constituted with CMOS sensor of 2,560×1,440 pixels. In addition, the image display unit 88 comprises a image display element 91 constituted with LCD of 640×480×3 pixels (R, G, B) with RGB stripe type color filter, a white light source 92 constituted with such as white LED for illuminating the image display element 91 and a pixel shifting unit 93 for shifting the display pixel position of the image display element 91.

In the present embodiment, the pixel shifting unit 93 is constituted as similar to the pixel shifting unit 63 of the fourth embodiment. The color image of 2,560×1,440 pixels obtained by imaging with the image pickup elements 81R, 81G and 82B is reduced the size into 640×480 pixels, and displayed with operated the four point pixel shifting by image display element 91 and pixel shifting unit 93. In addition, as it is easy to apply the image pickup elements 81R, 81G and 81B and the image display element 91 of the other size than the above, the explanations to them are omitted in the present specification.

Therefore, each acquired images of R, G, B of 2,560×1,440 pixels imaged by the image pickup elements 81R, 81G and 81B respectively are performed a front-end processing such as the correlation double sampling (CDS), the automatic gain control (AGC) or the analog/digital conversion (A/D) or a image processing in the imaging unit 81 or the signal processing unit (not shown in the figure), and consequently transmitted to the image division unit 82.

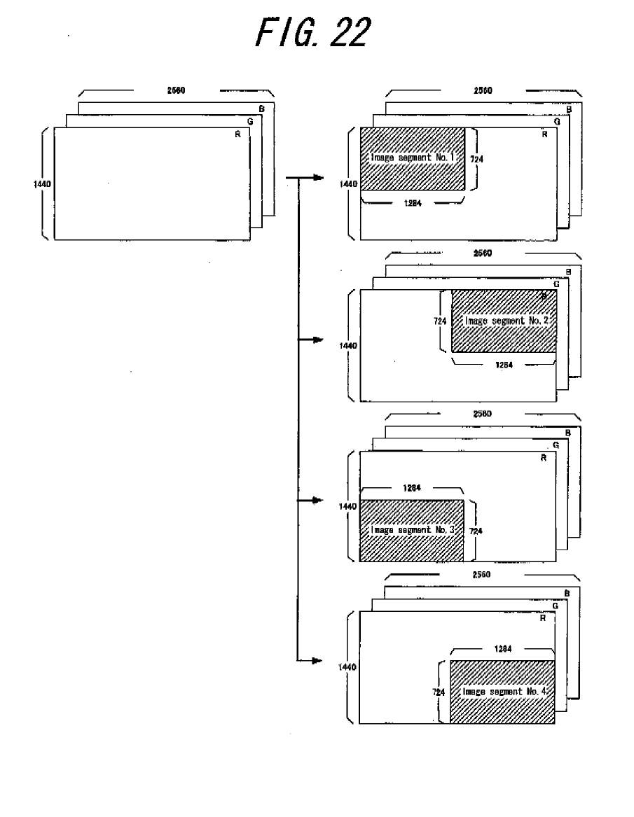

In the image division unit 82, each input images of R, G and B are divided, using the memory 83, into four image segments No.1 to No.4 of 1,284×724 pixels partly overlapping each other, as shown in FIG. 22. These image segments No.1 to No.4 are transmitted to the image reduction unit 83.

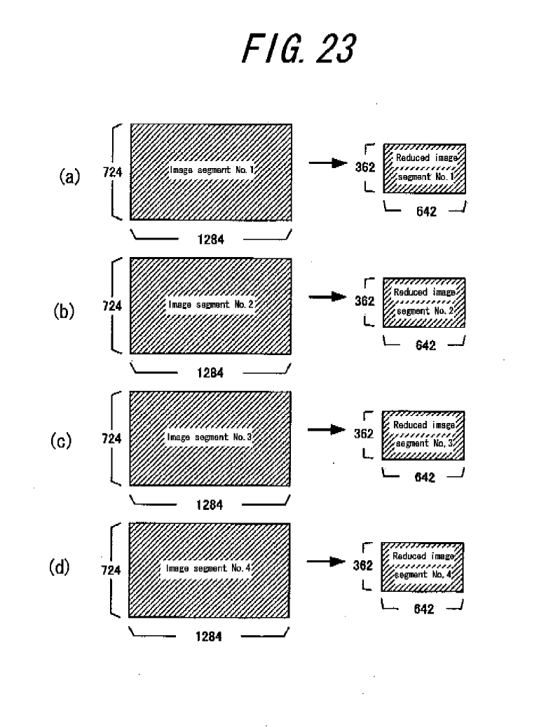

The image reduction unit 84 comprises four image reduction circuits 84a to 84d whose number is corresponding to the image division number of the image division unit 82. These image reduction circuits 84a to 84d scales the horizontal and vertical pixel number of the respective image segments No.1 to No.4 of 1,284×724 pixels into half using bicubic and the like, and generates the four reduced image segments No.1 to No.4 (scaling image segments) of 642×362 pixels respectively as shown in FIG. 23(a) to (d).

The four reduced image segments No.1 to No.4 generated in the image reduction unit 84 are transmitted to the output image formation unit 85. The output image formation unit 85 forms, from the transmitted reduced image segments No.1 to No.4, four output images No.1 to No.4 corresponding to number of pixel shifting in the image display unit 88. The formed output images are stored in the corresponding output image memory 86a to 86d in the output image memory unit 86.

Therefore, in the output image formation unit 85, assuming the odd columns (1st, 3rd, 5th . . . column) of odd lines (1st, 3rd, 5th . . . line) of the reduced image segments as “A”, the even columns (2nd, 4th, 6th . . . column) of odd lines of the reduced image segments as “B”, the odd columns of even lines (2nd, 4th, 6th . . . line) of the reduced image segments as “C” and the even columns of even lines of the reduced image segments as “D” as shown in FIG. 17, images formed only of the “A” of the respective reduced image segments (321×181 pixels), images formed only of the “B” of the respective reduced image segments (321×181 pixels), images formed only of the “C” of the respective reduced image segments (321×181 pixels), images formed only of the “D” of the respective reduced image segments (321×181 pixels) and images formed only of the “D” of the respective reduced image segments (321×181 pixels) can be formed. However, in the present embodiment, images of 320×180 pixels are formed from the respective reduced image segments so that respective overlaps are to be successive.

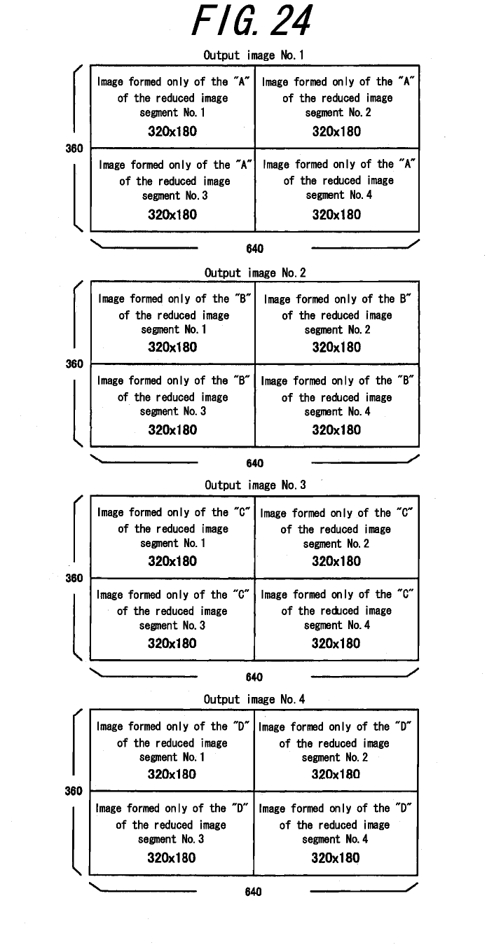

Subsequently, as shown in FIG. 24(a) to (d), images formed only of the “A” of the respective reduced image segments (320×180 pixels), images formed only of the “B” of the respective reduced image segments (32×180 pixels), images formed only of the “C” of the respective reduced image segments (320×180 pixels) and images formed only of the “D” of the respective reduced image segments (320×180 pixels) are combined to be output images No.1 to No.4 of 640×360 pixels so that overlap of respective reduced images are to be successive, and these output images are stored in corresponding output image memories 86a to 86d.

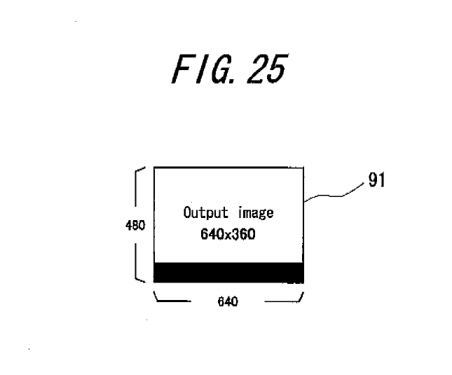

In addition, as pixel numbers (640×360 pixels) of each output images No.1 to No.4 is less than the effective pixel number (640×480 pixels) of the image display element 91 constituted with LCD, black data are put on the part of the displaying panel (on the parts where lacking the pixel of output images) of the image display element 91 as shown in FIG. 25 in the present embodiment.

According to the preset embodiment, similar to the forth embodiment, four output images No.1 to No.4 are displayed in the image display unit 88 with four point pixel shifting, so that the actual resolution of the image display element 91 can be displayed with doubled horizontal and vertical resolution. In addition, the device of the invention can be constituted in low price and to be able to perform high-speed processing, because the independent output images No.1 to No.4 of the display position A to D which are corresponding to those of four point pixel shifted images are formed from the four reduced image segments acquired by dividing the input image of 2,560×1,440 pixels in horizontal and vertical direction into four image segments and reducing the number of pixels of the image segments in horizontal and vertical direction into half size.

### Seventh Embodiment

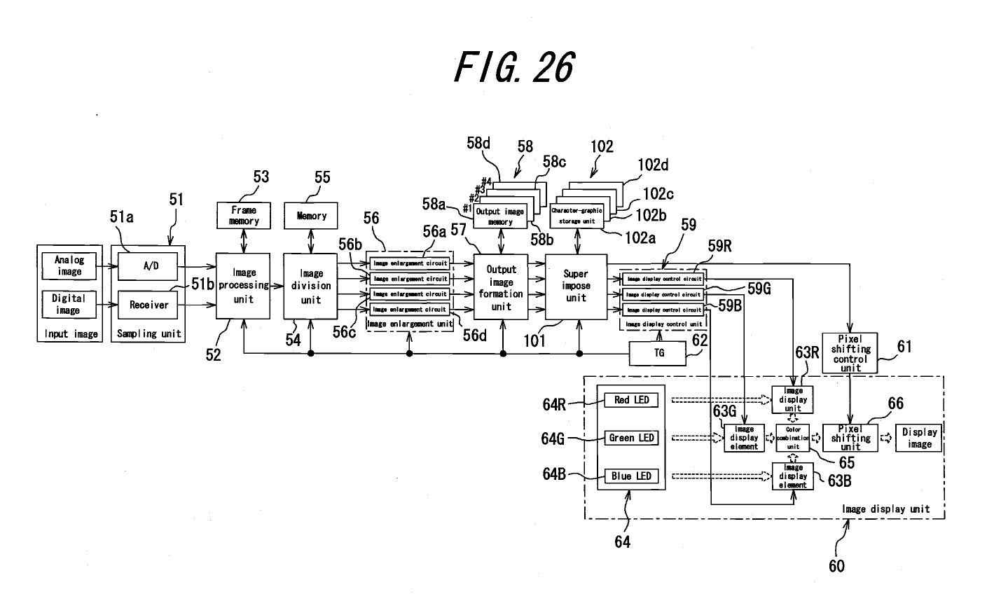

FIG. 26 is a block diagram showing the outline constitution of the image display device according to the seventh embodiment of the present invention. The image display device according to the present embodiment is the case of the fourth embodiment in which the pixel number of the input image data is not the integral multiplication of the display pixel number of the image display unit 60, in other words the aspect ratios of the input image data and the image display unit is not the same. In the present embodiment, the aspect ratio of the input data is 4:3 (1,600×1,200 pixels), and the aspect ratio of the image display elements 63R, 63G and 63B of the image display unit 60 is 16:9 (1,920×1,080 pixels) respectively. In addition, components in the FIG. 26 having the same function as that of FIG. 13 are referred to as the same referential, and the explanations for those are omitted.

In the same way as the fourth embodiment, the input image (1,600×1,200 pixels) is divided into for image segments of, for example, 804×604 pixels in the image division unit 54, and the divided images are scaled into the seize of 1.5 times by the image enlargement unit 56 to form the four enlarged image segments of 1,206×906 pixels. The four enlarged image segments are subsequently transmitted to the output image formation unit 57 to form our output images No.1 to No.4 of 1,200×900 pixels which spatially scoots down with each other.

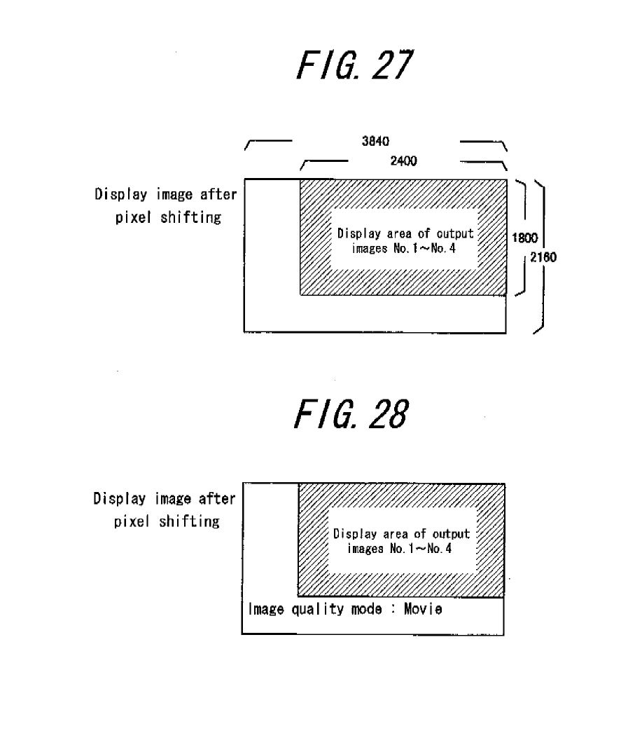

Herein, the pixel number of the output images No.1 to No.4 are 1,200×900 pixels respectively, and are less than that of the respective image display element 63R, 63G and 63B of the image display unit 60 (1,920×1,080 pixels). Therefore, there happens a waste in the display area of the image display element. Regarding the observation image after the four point pixel shifting, the displayable area is 3,840×2,160 pixels while the display area of the output images No.1 to No.4 is 2,400×1,800 pixels, so that there is a waste in the displayable area as shown in FIG. 27.

Consequently, in the present embodiment, the superimpose unit 101 is provided between the output image formation unit 57 and the image display control unit 59 as shown in FIG. 26. A character-graphic storage unit 102 is connected to the superimpose unit 101 to store the required characters, graphics, logos or images to be superimposed which are corresponding to the four output images No.1 to No.4 spatially scoots down with each other. In FIG. 26, four character-graphic memories 102a to 102d corresponding to the four output images No.1 to No.4 are provided in the character-graphic storage unit 102. Each required data for respective output images No.1 to No.4 are stored in the corresponding character-graphic memories 102a to 102d respectively.

In a same way, for example in the case of displaying the input images of TVs, a character data displaying an image quality mode as a required data is, for example, superimposed and displayed in the display area except the display area of the output images No. 1 to No.4 depending on the input image data as shown in FIG. 28. The other constitutions and the operations are same as those of the fourth embodiment.

According to the present embodiment, usability of the image display device is improved compared to that of the device according to the fourth embodiment because, in the case that the aspect ratios of the input image data and the image display unit 60 are different, the required data of the input image data can be superimposed and displayed in the wasted display area of the image display unit 60. In addition, though the four character-graphic memories 102a to 102d corresponding to the output images No.1 to No.4 respectively are provided in the character-graphic storage unit 102 in FIG. 26, the character-graphic storage unit 102 can be constituted with one memory by controlling the read out from the memory.

### Eighth Embodiment

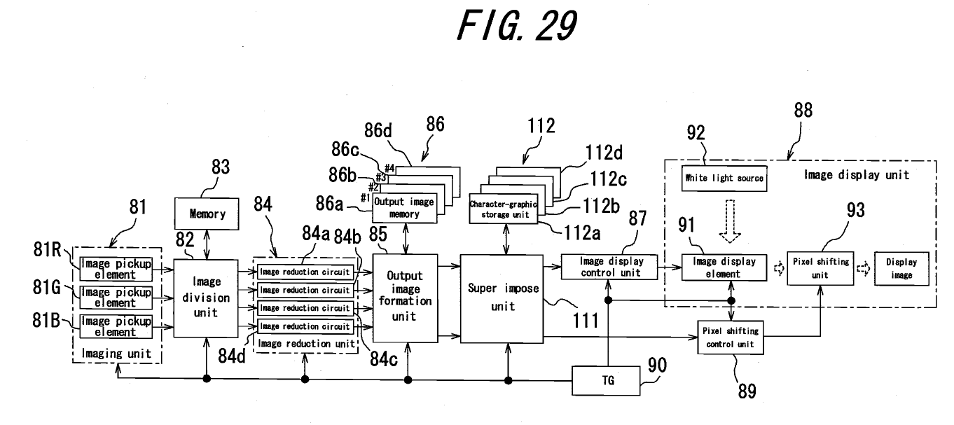

FIG. 29 is a block diagram showing the outline constitution of the image display device according to the eighth embodiment of the present invention. The present embodiment is, in the sixth embodiment shown in FIG. 21, provided the superimpose unit 111 between the output image formation unit 85 and the image display control unit 87 in the same way as the seventh embodiment, and the character-graphic storage unit 112 is provided in connection with the superimposed unit 111. Four character-graphic memories 112a to 112d are provided for storing the required characters, graphics, logos or images which are corresponding to the four output images No. 1 to No.4 spatially scoots down with each other.

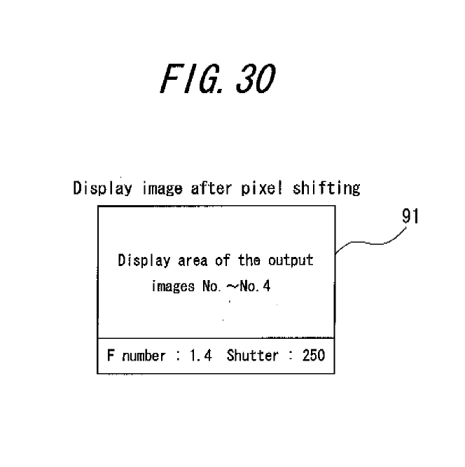

Consequently, instead of displaying image with putting black data on the part of display panel of image display element 91 where lacking the pixel of the output image No.1 to No.4 as shown in FIG. 25, it can be superimposed a character data showing F number of imaging or imaging condition such as shutter speed as a required data in the display area except the display area of the output images No.1 to No.4 as shown in FIG. 30 in the present embodiment, or it can be superimposed, though it is not shown in the figure, a character data for showing the imaging condition with overlapping the display area of the output image No.1 to No.4.

As shown in the above, in the present embodiment, usability of the image display device is improved compared to that of the device according to the sixth embodiment because a data of imaging can be superimposed in the display area of the image display unit 88.

Furthermore, the present invention is not limited to the embodiments described above and may be modified or changed in numerous ways. For example, in the third to eighth embodiments, as in the second embodiment, it is possible to provide an image division parameter input unit for setting the widths of the overlapping regions of the four image segments formed by dividing an output image by the image division unit 32. Moreover, the number of divisions of an output image does not necessarily coincide with the number of pixel shifting. In addition, in the sixth to eighth embodiments, as in the fifth embodiment, they can be constituted to perform two point pixel shifting.

### LISTING OF REFERENCE NUMERALS

11, 31 Input image memory
12, 32 Image division unit
13, 34 Image enlargement unit
14a, 14b, 35a to 35d Enlarged image segment memory
15, 36 Output image formation unit
16, 37a to 37d Output image memory
17, 38 Image display unit
18, 39 Image shifting control unit
19, 40 Timing generators (TG)
21 Image division parameter input unit
22a, 22b, 33a to 33d Image segment memory
34a to 34d Image enlargement circuit
36a to 36d Output image formation circuit
51 Sampling unit
52 Image processing unit
53 Frame memory
54 Image division unit
55 Memory
56 Image enlargement unit
57 Output image formation unit
58 Output image memory unit
59 Image display control unit
60 Image display unit
61 Pixel shifting control unit
62 Timing generator (TG)
63R, 63G and 63B Image display element
64 Light source unit
65 Color combination unit
66 Pixel shifting unit
67a and 67b Liquid crystal cell
68a and 68b Birefringent plate
71 Liquid crystal cell
72a and 72b Birefringent plate
81 Imaging unit
82 Image division unit
83 Memory
84 Image reduction unit
85 Output image formation unit
86 Output image memory unit
87 Image display control unit
88 Image display unit
89 Pixel shifting control unit
90 Timing generator (TG)
91 Image display element
92 White light source
93 Pixel shifting unit
101 and 111 Super impose unit
102 and 112 Character-graphic storage unit

1. An image display method comprising;
a step of dividing an output image into a plurality of image segments partly overlapping each other,
a step of enlarging said plurality of image segments, respectively, to form a plurality of enlarged image segments,
a step of forming from said plurality of enlarged image segments a plurality of output images corresponding to display positions spatially different from each other, and
a step of successively displaying said plurality of output images by an image display unit, while spatially shifting the display positions of the output images by said image display unit in a manner that said plurality of output images are successively displayed at the respective corresponding display positions by said image display unit.

2. An image display method comprising;
a step of sampling an input image,
a step of dividing said sampled image into a plurality of image segments partly overlapping each other,
a step of enlarging or diminishing said plurality of image segments, respectively, to form a plurality of scaling image segments,
a step of forming from said plurality of scaling image segments a plurality of output images corresponding to display positions spatially different from each other, and
a step of successively displaying said plurality of output images by an image display unit, while spatially shifting the display positions of the output images by said image display unit in a manner that said plurality of output images are successively displayed at the respective corresponding display positions by said image display unit.

3. An image display method comprising;
a step of capturing an image,
a step of dividing said captured image into a plurality of image segments partly overlapping each other,
a step of enlarging or diminishing said plurality of image segments, respectively, to form a plurality of scaling image segments,
a step of forming from said plurality of scaling image segments a plurality of output images corresponding to display positions spatially different from each other, and
a step of successively displaying said plurality of output images by an image display unit, while spatially shifting the display positions of the output images by said image display unit in a manner that said plurality of output images are successively displayed at the respective corresponding display positions by said image display unit.

4. An image display method comprising;
a step of sampling an input image,
a step of dividing said sampled image into a plurality of image segments partly overlapping each other,
a step of enlarging or diminishing said plurality of image segments, respectively, to form a plurality of scaling image segments,
a step of forming from said plurality of scaling image segments a plurality of output images corresponding to display positions spatially different from each other, a step of superimposing the data necessary for said plurality of output images respectively, and
a step of successively displaying said plurality of superimposed output images by an image display unit, while spatially shifting the display positions of the output images by said image display unit in a manner that said plurality of superimposed output images are successively displayed at the respective corresponding display positions by said image display unit.

5. An image display method comprising;
a step of capturing an image,
a step of dividing said captured image into a plurality of image segments partly overlapping each other,
a step of enlarging or diminishing said plurality of image segments, respectively, to form a plurality of scaling image segments,
a step of forming from said plurality of scaling image segments a plurality of output images corresponding to display positions spatially different from each other,
a step of superimposing the data necessary for said plurality of output images respectively, and
a step of successively displaying said plurality of superimposed output images by an image display unit, while spatially shifting the display positions of the output images by said image display unit in a manner that said plurality of superimposed output images are successively displayed at the respective corresponding display positions by said image display unit.

6. An image display device comprising;
an image division unit for dividing an input image into a plurality of image segments partly overlapping each other,
an image enlargement unit for enlarging said plurality of image segments to form a plurality of enlarged image segments,
an output image formation unit for forming from said plurality of enlarged image segments a plurality of output images corresponding to display positions spatially different from each other,
an image display unit for successively displaying said plurality of output images, and
a pixel shifting control unit for spatially shifting the display positions indicated by said image display unit so that the respective output images are displayed at their corresponding display positions synchronizing with the successive displays of said plurality of output images.

7. An image display device comprising;
a sampling unit for sampling an input image,
an image division unit for dividing said image sampled by said sampling unit into a plurality of image segments partly overlapping each other,
an image scaling unit for forming a plurality of scaling image segments by enlarging or diminishing said plurality of image segments divided by said image division unit respectively,
an output image formation unit for forming from said plurality of scaling image segments formed by said image scaling unit a plurality of output images corresponding to display positions spatially different from each other,
an image display unit for successively displaying said plurality of output images formed by said output image formation unit, and
a pixel shifting control unit for spatially shifting the display positions indicated by said image display unit so that the respective output images are displayed at their corresponding display positions synchronizing with the successive displays of said plurality of output images on said image display unit.

8. An image display device comprising;
a image capturing unit for capturing an image,
an image division unit for dividing the image captured by said image capturing unit into a plurality of image segments partly overlapping each other,
an image scaling unit for forming a plurality of scaling image segments by enlarging or diminishing said plurality of image segments divided by said image division unit respectively,
an output image formation unit for forming from said plurality of scaling image segments formed by said image scaling unit a plurality of output images corresponding to display positions spatially different from each other,
an image display unit for successively displaying said plurality of output images formed by said output image formation unit, and
a pixel shifting control unit for spatially shifting the display positions indicated by said image display unit so that the respective output images are displayed at their corresponding display positions synchronizing with the successive displays of said plurality of output images on said image display unit.

9. An image display device comprising;
a sampling unit for sampling an input image,
an image division unit for dividing said image sampled by said sampling unit into a plurality of image segments partly overlapping each other,
an image scaling unit for forming a plurality of scaling image segments by enlarging or diminishing said plurality of image segments divided by said image division unit respectively,
an output image formation unit for forming from said plurality of scaling image segments formed by said image scaling unit a plurality of output images corresponding to display positions spatially different from each other,
a superimpose unit for superimposing the data necessary for the plurality of output images formed by said output image formation unit respectively, an image display unit for successively displaying the plurality of output images superimposed by said superimpose unit, and
a pixel shifting control unit for spatially shifting the display positions indicated by said image display unit so that the respective output images are displayed at their corresponding display positions synchronizing with the successive displays of said plurality of superimposed output images on said image display unit.

10. An image display device comprising;
a image capturing unit for capturing an image,
an image division unit for dividing the image captured by said image capturing unit into a plurality of image segments partly overlapping each other,
an image scaling unit for forming a plurality of scaling image segments by enlarging or diminishing said plurality of image segments divided by said image division unit respectively, an output image formation unit for forming from said plurality of scaling image segments formed by said image scaling unit a plurality of output images corresponding to display positions spatially different from each other,
a superimpose unit for superimposing the data necessary for the plurality of output images formed by said output image formation unit respectively,
an image display unit for successively displaying the plurality of output images superimposed by said superimpose unit, and
a pixel shifting control unit for spatially shifting the display positions indicated by said image display unit so that the respective output images are displayed at their corresponding display positions synchronizing with the successive displays of said plurality of superimposed output images on said image display unit.

11. An image display device as claimed in claim 6, comprising an image division parameter input unit for setting overlapping regions of said plurality of image segments formed by said image division unit.

12. An image display device as claimed in claim 6, comprising a plurality of image segment memories for memorizing said plurality of image segments, respectively, a plurality of enlarged image segment memories for memorizing said plurality of enlarged image segments, respectively, and a plurality of output image memories for memorizing said plurality of output images, respectively.

13. An image display device as claimed in claim 6, wherein said image enlargement unit comprises a plurality of image enlargement circuits for enlarging said plurality of image segments, respectively, and said output image formation unit comprises a plurality of output image formation circuits for forming said plurality of output images, respectively.

14. An image display device as claimed in claim 7, comprising an image division parameter input unit for setting overlapping regions of said plurality of image segments formed by said image division.

15. An image display device as claimed in claim 8, comprising an image division parameter input unit for setting overlapping regions of said plurality of image segments formed by said image division.

16. An image display device as claimed in claim 9, comprising an image division parameter input unit for setting overlapping regions of said plurality of image segments formed by said image division.

17. An image display device as claimed in claim 10, comprising an image division parameter input unit for setting overlapping regions of said plurality of image segments formed by said image division.

18. An image display device as claimed in claim 7, comprising a plurality of image segment memories for memorizing said plurality of image segments, respectively, a plurality of enlarged image segment memories for memorizing said plurality of enlarged image segments, respectively, and a plurality of output image memories for memorizing said plurality of output images, respectively.

19. An image display device as claimed in claim 8, comprising a plurality of image segment memories for memorizing said plurality of image segments, respectively, a plurality of enlarged image segment memories for memorizing said plurality of enlarged image segments, respectively, and a plurality of output image memories for memorizing said plurality of output images, respectively.

20. An image display device as claimed in claim 9, comprising a plurality of image segment memories for memorizing said plurality of image segments, respectively, a plurality of enlarged image segment memories for memorizing said plurality of enlarged image segments, respectively, and a plurality of output image memories for memorizing said plurality of output images, respectively.

21. An image display device as claimed in claim 10, comprising a plurality of image segment memories for memorizing said plurality of image segments, respectively, a plurality of enlarged image segment memories for memorizing said plurality of enlarged image segments, respectively, and a plurality of output image memories for memorizing said plurality of output images, respectively.

22. An image display device as claimed in claim 11, comprising a plurality of image segment memories for memorizing said plurality of image segments, respectively, a plurality of enlarged image segment memories for memorizing said plurality of enlarged image segments, respectively, and a plurality of output image memories for memorizing said plurality of output images, respectively.

23. An image display device as claimed in claim 7, wherein said image enlargement unit comprises a plurality of image enlargement circuits for enlarging said plurality of image segments, respectively, and said output image formation unit comprises a plurality of output image formation circuits for forming said plurality of output images, respectively.

24. An image display device as claimed in claim 8, wherein said image enlargement unit comprises a plurality of image enlargement circuits for enlarging said plurality of image segments, respectively, and said output image formation unit comprises a plurality of output image formation circuits for forming said plurality of output images, respectively.

25. An image display device as claimed in claim 9, wherein said image enlargement unit comprises a plurality of image enlargement circuits for enlarging said plurality of image segments, respectively, and said output image formation unit comprises a plurality of output image formation circuits for forming said plurality of output images, respectively.

26. An image display device as claimed in claim 10, wherein said image enlargement unit comprises a plurality of image enlargement circuits for enlarging said plurality of image segments, respectively, and said output image formation unit comprises a plurality of output image formation circuits for forming said plurality of output images, respectively.

27. An image display device as claimed in claim 11, wherein said image enlargement unit comprises a plurality of image enlargement circuits for enlarging said plurality of image segments, respectively, and said output image formation unit comprises a plurality of output image formation circuits for forming said plurality of output images, respectively.

28. An image display device as claimed in claim 12, wherein said image enlargement unit comprises a plurality of image enlargement circuits for enlarging said plurality of image segments, respectively, and said output image formation unit comprises a plurality of output image formation circuits for forming said plurality of output images, respectively.
